(19) United States
(12) Patent Application Publication
(10) Pub. No.: US 2023/0237363 A1
(43) Pub. Date: Jul. 27, 2023

(54) Classical Algorithm for Generating Multi-Mode Bosonic Transition Spectra by Phase Space Sampling

(71) Applicant: The University of Chicago, Chicago, IL (US)

(72) Inventors: Changhun Oh, Chicago, IL (US); Youngrong Lim, Seoul (KR); Yat Wong, Chicago, IL (US); William Fefferman, Chicago, IL (US); Liang Jiang, Chicago, IL (US)

(21) Appl. No.: 18/156,254

(22) Filed: Jan. 18, 2023

Related U.S. Application Data
(60) Provisional application No. 63/300,320, filed on Jan. 18, 2022.
(60) Provisional application No. 63/393,048, filed on Jul. 28, 2022.

(51) Int. Cl. G06N 10/60

(52) U.S. Cl. CPC G06N 10/60

(57) ABSTRACT

This disclosure relates to a method and system for efficiently and analytically generating spectra associated with transitions between thermal states in a multi-mode bosonic system using a classical algorithm to compute Fourier components of the transition spectra of the multi-mode bosonic system based on a representation space sampling method inspired by quantum Gaussian boson sampling followed by an inverse Fourier transform. The disclosed method and system particularly apply to efficient estimation of molecular vibronic spectra. For example, an exact solution of the Fourier components of molecular vibronic spectra at zero temperature may be analytically computed in a representation space by using, for example, a positive P-representation of the multi-mode bosonic vibronic quantum states of the molecule. Such a method may be further applied to more general vibronic spectroscopy, such as computing molecular vibronic spectra at finite temperatures by introducing additional auxiliary bosonic modes and computing vibronic spectra associated with non-thermal states, such as Fock states.

### CROSS REFERENCE

This application is based on and claims the benefit of priority to U.S. Provisional Patent Application Nos. 63/300,320 and 63/393,048 filed on Jan. 18, 2022 and Jul. 28, 2022, respectively. These prior provisional patent applications are herein incorporated by reference in their entireties.

### GOVERNMENT FUNDING

This invention was made with government support under grant numbers W911 NF-18-1-0020, W911 NF-18-1-0212, W911 NF-16-1-0349, and W911 NF-21-1-0325 awarded by the Army Research Office, grant numbers FA9550-19-1-0399, FA9550-21-1-0209, FA8649-21-P-0781, FA9550-18-1-0148, and FA9550-21-1-0008 awarded by Air Force Office of Scientific Research, grant numbers 1640959, 1936118, 1941583, 2137642, and 2044923 awarded by the National Science Foundation, and grant number DE-SC0020360 awarded by the Department of Energy. The government has certain rights in the invention.

### FIELD OF THE INVENTION

This disclosure relates to a method and system for efficiently generating spectra associated with transitions between thermal states in a multi-mode bosonic system using a classical algorithm based on a phase space sampling method inspired by a quantum Gaussian boson sampling methodology. The disclosed method and system particularly apply to efficient estimation of molecular vibronic spectra.

### BACKGROUND OF THE INVENTION

Vibronic spectra represent an essential and characteristic property of a molecule composition and structure. As such, molecular vibronic spectra may be relied upon to analyze chemical composition of molecules and to study molecular structures. Molecular vibronic spectra of a plurality of reference molecular structures may be computationally generated and used as a library of molecular fingerprints for experimentally identifying and studying molecular compounds. However, the computation of vibronic spectra of a particular molecular structure has been known to be a challenging task, with its complexity rapidly growing with the size and/or the number of vibrational modes of the molecular structure. For example, the best-known classical algorithm scales combinatorially with the size of the molecular system. While a quantum simulator, particularly the ones based on Gaussian boson sampling of multi-mode photons, may be implemented to efficiently generate the characteristic molecular vibronic spectra, such a simulator does require a quantum computing machine, such as a linear optical circuits constructed to process delicate non-classical photonic states generated by non-classical photon sources.

### SUMMARY OF THE INVENTION

This disclosure relates to a method and system for efficiently and analytically generating spectra associated with transitions between thermal states in a multi-mode bosonic system using a classical algorithm to compute Fourier components of the transition spectra of the multi-mode bosonic system based on a representation space sampling method inspired by quantum Gaussian boson sampling followed by an inverse Fourier transform. The disclosed method and system particularly apply to efficient estimation of molecular vibronic spectra. For example, an exact solution of the Fourier components of molecular vibronic spectra at zero temperature may be analytically computed in a phase space by using, for example, a positive P-representation of the multi-mode bosonic vibronic quantum states of the molecule. Such a method may be further applied to more general vibronic spectroscopy, such as computing molecular vibronic spectra at finite temperatures by introducing additional auxiliary bosonic modes and computing vibronic spectra associated with non-thermal states.

In some example implementations, a method for estimating a transition spectra in a bosonic system is disclosed. The bosonic system may be associated with M bosonic modes, M being an integer equal to or larger than 2. The method may include determining a unitary operation modified from a transition operator associated with the bosonic system; processing each of N sampling bosonic states of the bosonic system in a representation space of the bosonic system to generate N sets of samples using at least the unitary operation, wherein each set of samples correspond to one of the N sampling bosonic states and are sampled from at least one variable in the representation space, N being a positive integer; analytically generating Fourier components the transition spectra based on the N sets of samples; and inverse-transforming the Fourier components to estimate the transition spectra.

In any one of the example implementations above, the unitary operation may include a complex mixed position and momentum operator.

In any one of the example implementations above, each of the N sampling bosonic states may be a non-Gaussian state of the M bosonic modes.

### BRIEF DESCRIPTION OF THE DRAWINGS

For a more complete understanding of the invention, reference is made to the following description and accompanying drawings, in which:

FIG. 1 illustrates molecular vibronic spectra generation process based on a quantum Gaussian algorithm and a quantum-inspired classical algorithm;

FIG. 2 shows an example data and logic flow for the quantum-inspired classical algorithm of FIG. 1 for generating molecular vibronic spectra;

FIG. 3 shows comparison of molecular vibronic spectra for CH₂O₂, 1¹A′→1² A′ as generated based on direct computation (ideal bars) and based on the quantum-inspired classical and analytical algorithm of FIG. 1 (“Analytical Solution” points and curve);

FIG. 4 illustrates transformation of molecular vibronic spectra at finite temperature (upper) and treating the problem by introducing auxiliary modes and two-mode squeezing operation and using the zero-temperature algorithm (lower);

FIG. 5 illustrates transformation of molecular vibronic spectra with a Fock state as an input;

FIG. 6 illustrates comparison of molecular vibronic spectra for CH₂O₂, 1¹ A′→1² A′ as generated based on direct computation (ideal bars) and based on Gaussian boson sampling simulation (“GBS” points and curve);

FIG. 7 illustrates comparison of total variance distance (TVD) between ideal direct computation (upper curve with circular points) and the quantum-inspired classical algorithm (lower curve with triangular points) of FIG. 3 (the insert is in logarithm scale);

FIG. 8 illustrates virtual ideal vibronic spectra and empirical vibronic spectra generated using the classical algorithm with N=10⁵ samples and with a total variation distance is of 0.00222;

FIG. 9 illustrates virtual ideal vibronic spectra and empirical vibronic spectra generated by Gaussian boson sampling experimental raw data with N=10⁶ samples and with a total variation distance of 0.01215; and

FIG. 10 illustrates Virtual FCP with a randomly generated weights for all 144 vibronic modes of a molecular system. The unit of wave number is cat. The generation of each instance using classical algorithm costs about 90 secs using a single core computing system.

### DETAILED DESCRIPTION

### Bosonic Systems and Molecular Vibronic Spectra

Atomic/nuclear components of a compound molecular structure interact with one another and thus may vibrate in multiple number (e.g., integer M) of vibrational modes. Each vibrational mode, approximately, may be modeled as a harmonic oscillator of a particular frequency. The multiple vibrational modes thus may correspond to a multitude of characteristic vibrational frequencies cv, within the molecular structure, where i∈[1, 2, . . . , M]. Quantum mechanically, vibrations in each of the modes may be described by quantum states |mᵢ [symbol] (where mᵢ∈[0, 1,]) with ladder-like energy levels each associated with a quantum number mᵢ and an energy determined by [symbol] ωᵢ(mᵢ−½) (for mᵢ=0, 1, 2, . . . , ∞), where the vacuum level is represented by [symbol] ωᵢ/2. An arbitrary molecular vibrational state thus may be described by a quantum superposition of these multi-mode base states. The molecular vibrations may thus be considered a bosonic system, similar to a system of multi-mode photons. For convenience, a molecular vibrational quanta may be referred to as a photon in this disclosure.

The various vibrational modes are essential characteristics of a molecular structure. Molecular vibrations may be further coupled to the electronic states or transitions in the molecule. For example, electronic transitions may change or perturb the nuclear structure of the molecule, thereby introducing new sets of vibrational modes. The vibrational modes of a molecular may be investigated spectroscopically, for example, as fine spectral lines or structures within an electronic transition spectra. Such spectra may be referred to as molecular vibronic spectra. Vibronic spectra thus represent a fundamental property of a molecule. As such, molecular vibronic spectra may be relied upon to analyze chemical compositions and study molecular structures. In many circumstances, computation of such spectra may be critical in order to derive a molecular structure based on measured vibronic spectra. For example, molecular vibronic spectra of a plurality of reference molecular structures may be computationally generated and used as a library of molecular fingerprints for experimentally identifying and studying molecular compounds.

However, traditional classical computation of vibronic spectra of a particular molecular structure has been known to be a challenging task, with its complexity rapidly growing with the size and/or the number of the vibrational modes of the molecular structure. For example, as shown below, the best-known classical algorithm scales combinatorially with the size of the molecular system. While a quantum simulator, particularly the ones based on Gaussian boson sampling of multi-mode photons, may be implemented to efficiently generate the characteristic molecular vibronic spectra, such a simulator does require a quantum computing machine, such as a linear optical circuits constructed to process delicate non-classical photonic states generated from a non-classical multi-mode photon source, which is usually challenging from experimental standpoint.

In this disclosure, a method and system for efficiently generating molecular vibrational spectra associated with transitions between vibrational thermal states in a molecular structure are described. The disclosed method and system are based on a quantum inspired classical algorithm. In particular, the disclosed classical algorithm analytically obtain Fourier components of the molecular vibrational spectra at zero temperature by sampling phase-space variables in a positive P-representation of a thermal multi-mode molecular vibrational state. Such a sampling technique is inspired by a quantum approach involving Gaussian boson sampling. While this algorithm relies on a quantum-inspired simulation, it nevertheless provides an exact and efficient solution of the Fourier components of molecular vibronic spectra in a classical manner without needing a quantum simulator. The molecular vibrational spectra may then be generated by performing inverse Fourier transform of the Fourier components. Such a method is further extended to generate molecular vibronic spectra at finite temperatures by introducing additional auxiliary modes and two-mode squeezing operations.

In more general cases, a Fock state rather than a thermal state as an initial state may be considered. The Fock state may correspond to single vibronic levels and may be written as a loop halfnian of a matrix. A Monte Carlo method using the positive P-representation may be used to estimate the molecular vibronic spectra in that case. However, the Monte Carlo method becomes inefficient when the number of quanta in the initial Fock states grows. In some other implementations of a similar method setup in single-photon boson rather than multi-photon sampling to obtain corresponding virtual molecular vibronic spectra, the corresponding Fourier components may become hard to compute (#P-hard), in stark contrast to Gaussian boson sampling which has an exact solution, rendering a computational advantage for Gaussian boson sampling over single-photon boson sampling. Nonetheless, a practically relevant question is whether the Fourier components can be additively approximated to within the same 1/poly(N) accuracy that can be obtained using N number of samples for a boson sampling experiment. Interestingly, when squeezing parameters are zero, the quantity reduces to a permanent, which can be approximated by Gurvits's algorithm within an additive error. As such, an approximation method may be implemented to tackle the problem using the positive P-representation with post-selection and another method that approximates a loop hafnian. While there may be a limitation of the method of positive P-representation with post-selection as the number of quanta in the initial Fock state grows, a regime may be identified where the approximation error can be efficiently controlled even for large system size.

While the example implementations below are provided in the context of molecular vibronic spectral generation, the underlying principles and procedure may be applicable to generating transition spectra in other multi-mode bosonic systems.

### Example Implementations of Quantum-Inspired Classical Algorithm for Estimating Molecular Vibronic Spectra

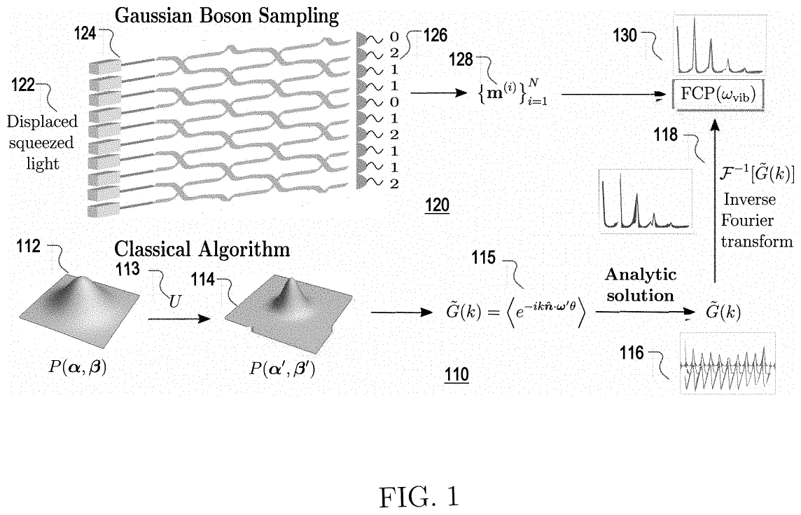

An example procedure for analytically generating molecular vibronic spectra using an efficient classical algorithm is shown in FIG. 1 in comparison to a typical quantum simulator for the same purposes. In particular, the analytical and classical algorithm is shown by the lower data-flow path 110 whereas the quantum simulation procedure is illustrated by the upper data-flow path 120. For both approaches, the computational output includes the vibronic spectra 130 for the zero temperature molecule (e.g., absorption vibronic spectra), although the example method/system disclosed herein can be expanded in non-zero temperatures, as described in further detail below.

For the quantum simulation data path 120, an example Gaussian boson sampling procedure may be performed. For example, a product quantum state of single-mode Gaussian quantum states of multi-mode (e.g., M-mode) photons may be initially determined, prepared, and generated from appropriately configured and controlled photon sources. Such a product quantum state may represents a dressed and displaced initial state (e.g., vacuum state for zero temperature and generated as an input dressed and displaced M-mode photon state, as shown by 122, to a quantum circuit 124. The quantum circuit 124 may include a plurality of beam splitters and other linear optical components to simulate a unitary quantum operation. A quantum unitary operator associated with the quantum circuit 124 may be determined in accordance with example implementations described in further detail below.

For example, the unitary operator corresponding to the unitary quantum operation of the quantum circuit 124, in combination with the dressing operator and the displacement operator for generating the dressed and displaced initial quantum state of the input product quantum state of the M-mode photon state, may correspond to a transition operator of the molecular system between the ground state and vibronic thermal states. The linear optical components of the quantum processing circuit may thus be configured to preform the operation corresponding to the unitary operator. The output of the linear operation may then be projected to the various photon modes and detected as photon numbers in the M photon modes, {m}. The array of linear optical components and the detection in the M-photon modes are thus equivalent to a Gaussian Boson sampler, as shown by 124 and 126.

A set of N samples, represented by S={m⁽ⁱ⁾}ᵢ₌₁^{N} and as shown by 128 in FIG. 1, may be selected. The samples may then be post processed by first being sorted according to total energy of each sample, where the total energy of each sample corresponds to the energy of all vibronic quanta (e.g., m⁽ⁱ⁾·ω′, where ω′ represents the M-mode frequencies). In some practical implementations, for a particular spectra frequency, ω_{vib}, a window Δω_{vib}, may be introduced for the post processing procedure. In other words, when a samples total energy-equivalent frequency m⁽ⁱ⁾·ω′ lies between [ω_{vib}−Δω_{vib}/2, ω_{vib}+Δω_{vib}/2] for a certain ω_{vib}, the count for a bin corresponding to ω_{vib}, is incremented. The distribution of final counts in all ω_{vib} bins forms the simulated molecular vibronic spectra FCP(ω_{vib}), as long as sufficient N number of samples are collected from the quantum linear optical circuit and are post processed.

In some example implementations, a classical algorithm may be implemented as shown by the procedure 110 in FIG. 1. While such an algorithm as described in further detail below is inspired by the quantum Gaussian boson sampling procedure described above (procedure 120 of FIG. 1), it nevertheless would not need to rely on an actually quantum simulation machine. In order to generate molecular vibronic spectra due to transition to vibronic states at zero temperature, a particular quantum state of the multi-mode molecular vibronic state may be determined as an input state to the classical algorithm. Such an input vibronic state may be a general M-mode vibronic state determined and generated for an initial state of the molecule (e.g., a vacuum state at zero temperature, a Gaussian state at a finite initial temperature, or Fock state, and the like). Such an input vibronic state corresponding to an initial vacuum state at zero temperature, for example, may be a Gaussian state associated with the M vibronic modes. In some example implementations, the input M-mode vibronic quantum state of the molecule to the disclosed classical algorithm may be represented in a phase space as a quasi-probability distribution of a set of phase space variables associated with the phase space. Such a phase-space representation of a quantum state may be referred to as a P-representation.

An important property of a generalized P-representation may be that the underlying phase-space distribution may always be chosen non-negatively such that the expectation value of a normal-ordered operator can be readily estimated by sampling from the distribution. Such non-negative phase-space distribution may be referred to as positive P-representation.

Unlike traditional classical algorithm for the calculation of molecular vibronic spectra, the quantum-inspired classical algorithm can provide fast and efficient estimation of the molecular vibronic spectra. The gain of such a classical algorithm over traditional classical calculation with complexity that grows combinatorially with respect to the size of the problem or the number of the vibronic modes of the molecular system mostly relies on the principle that information being sought or of interest (e.g., the molecular vibronic spectra) represents a coarse information that need not require detailed knowledge whose calculation cannot be avoided when the traditional classical calculation method is being used. The example quantum-inspired algorithm described below preforms sampling and analytics that more resemble the quantum simulation in that it is not capable of revealing or calculating these knowledge items pertinent to the molecular vibronic system, and fortunately, those knowledge items are not necessary and thus need not be calculated for the estimation of the molecular vibronic spectra of interest.

As shown in 110 of FIG. 1, this classical algorithm starts by preparing an input state of the M-mode molecular vibronic system based on an initial vibronic state of interest (e.g., a vacuum state at zero temperature, a Gaussian state at a finite temperature, a Fock state, and the like). For an initial vacuum state, the input state may correspond to an Gaussian state, as described in further detail below. Merely as an example, the input state may be expressed in the P-representation in a phase space. Again, the P-representation may be characterized by a quasi-probability distribution function of a bosonic state over the phase space that can always be chosen non-negative. For example the phase space variables for the quasi-probability distribution function of the P-representation may include a set of M-dimensional vectors. For a particular example, the phase space variables may include a set of two M-dimensional vectors. In FIG. 1, such example quasi-probability distribution function of the example input Gaussian state is shown by 112 and represented by P(α, β), where α and β represent the set of two M-dimensional vectors.

As further shown in 110 of FIG. 1, the input state of the M-mode molecular vibronic state as represented by P(α, β) may then be transformed to generate a transformed P-representation P(α′,β′), as shown by 114, by applying an operator U, shown by 113, to the set of two phase space variables α and β to transform them into α′ and β′. The phase space of α and β may be further sampled. Specifically, 2M complex numbers of (α, β) may be sampled. The 2M samples may be transformed by the operator U, as expressed by (α, β)→(α′, β′)=(Uα, Uβ). The operator U is implemented as a matrix and represents the transmission/transition matrix for the M-mode molecular system in the phase space. The operator U, for example, may comprise a mix of position and momentum operators.

As further shown by 115 of FIG. 1, Fourier components of the molecular vibronic spectra may be estimated classically from the phase space sampling above. Such estimate may be exact or may be approximated to a certain predetermined error level. For example, the Fourier components of the molecular vibronic spectra may by represented by \tilde{G}(k), where k represents the Fourier space of the molecular vibronic spectra. The classical process for estimating \tilde{G}(k) from the transformed sampled phase space variables (α′, β′) is provided in further detail below for various initial and input states of the M vibronic modes of the molecule. Such estimate may be based on a correspondence between the Fourier components of the molecular vibronic spectra and an effective photon number operator \hat{n}, as shown by 115 of FIG. 1. The estimated Fourier components \tilde{G}(k) are exemplarily illustrated in 116 of FIG. 1. Thereafter, the estimated Fourier components \tilde{G}(k) may then be used to generate the molecular vibronic spectra 130 via a classical inverse Fourier transform process, as indicated by 118 in FIG. 1.

Although the example of FIG. 1 illustrates sampling in the P representation phase space, the underlying principles apply to implementations where the sampling is performed in other spaces. Other representations or spaces may be used under different circumstances, depending on, for example, the initial state of the molecular system. For example, the sampling space may be generally a mix of position and momentum.

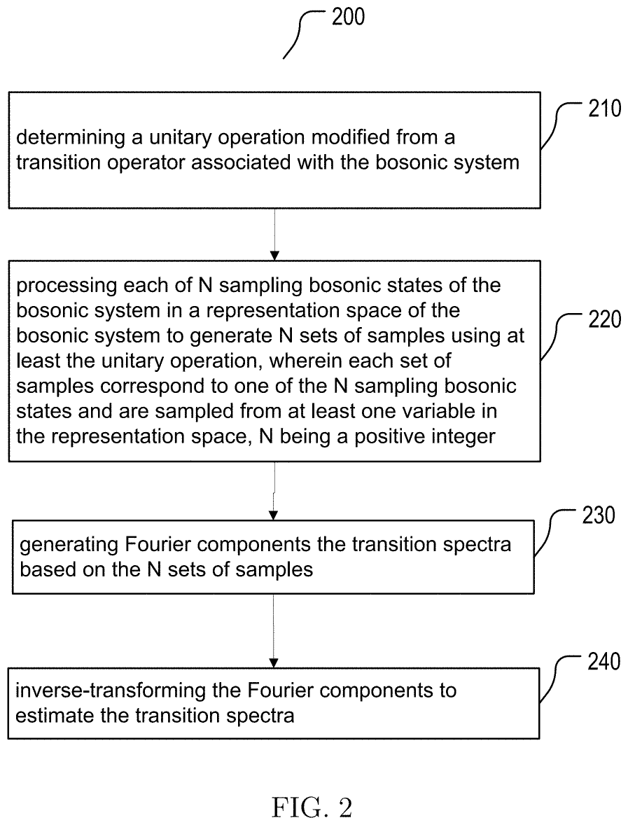

The example procedure above for estimating the molecular vibronic spectra in the quantum-inspired classical manner is further described in the data and logic flow 200 of FIG. 2. As shown in FIG. 2, the data and logic flow may include step 210 for determining a unitary operation configured to project an input superposition state of the bosonic system into number states corresponding to the M bosonic modes. Such an input state may be determined form an initial state of moledule system. For example, such an input state may be a Gaussian state of the M bosonic modes corresponding to an vacuum initial state at zero temperature, for calculating zero-temperature vibronic spectra of the molecule.

In step 220, each of N sampling bosonic states of the bosonic system may be processed in a representation space of the bosonic system e.g., a phase space to generate N sets of samples based on at least the unitary operation, wherein each set of samples correspond to one of the N sampling bosonic states and are sampled from at least one variable in the representation space, N being a positive integer.

In step 230, Fourier components the transition spectra may be analytically generated based on the N sets of samples. Such generation may be exact or may be approximate to a predetermined error level corresponding to the size (number of vibronic modes) of the molecule.

In step 240, inverse-transformation may be performed on the Fourier components to estimate the transition spectra. The correspondence between the Fourier components and the final transition spectra may be exact or may be approximate to a predetermined error level corresponding to the size (number of vibronic modes) of the molecule for different initial and input sates, as described in further detail below.

The example implementations above may be applied to generate vibronic spectral for a molecular system at zero temperature. In particular, the initial vibronic state of the molecular system would be the vacuum state of all M modes. The corresponding input state to the sampling process above may be an Gaussian state of the M vibronic modes, and the correspondence between the Fourier components and the final transition spectra may be exact, as described in further detail below. The representation space in such a case may be the P-representation space.

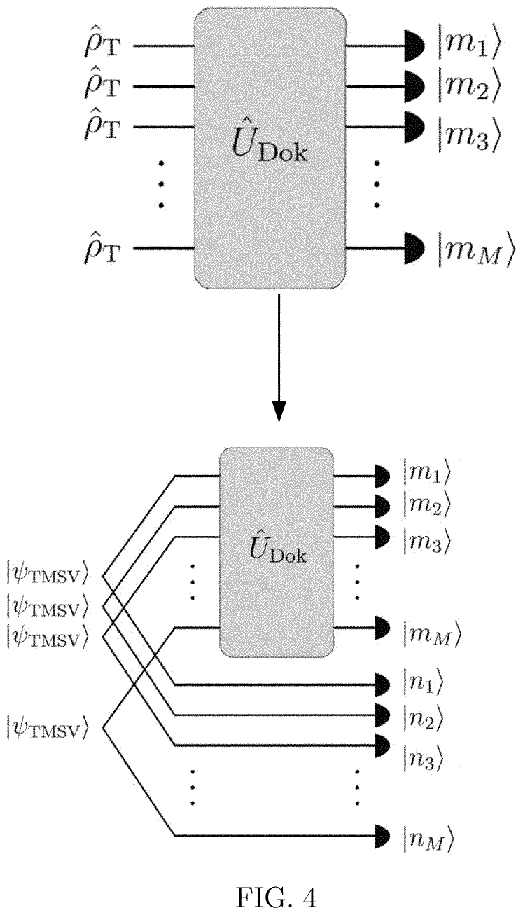

In some other specific example implementations, vibronic spectra may be estimated for a molecular system at a finite non-zero temperature following the zero-temperature implementation. For example, as described in further detail below, M auxiliary modes may be added in comparison to the zero-temperature case. Two-mode squeezed states may be prepared to simulate thermal states and detect the additional auxiliary modes as well, as depicted in FIG. 4 and described in further detail below. As such, the procedure described above and in the data and logic flow of FIG. 2 for estimating zero-temperature vibronic spectra of the molecular system applies to the finite temperature situation, except that, as a cost, the additional M auxiliary modes are included in the preparation of the input Gaussian state and in the sampling in the phase space.

In yet some other example implementations, the sampling method above may be applied to an estimation of molecular vibronic spectra for non-Gaussian initial state, such as a Fock state. In order to employ a mapping from molecular vibronic spectra to Gaussian boson sampling, additional M modes and two-mode squeezed states of some squeezing parameters may be introduced. In comparison to the finite temperature Gaussian initial state case, a post selection may be further performed for the additional modes. As described in further detail below, the estimation of the Fourier components may not be exact in such a situation. The error may exponentially increase with the photon number in the initial Fock state, suggesting an exponential increase in samples needed according to the sampling process of FIGS. 1 and 2. However, as described in further detail below, the above sampling process may be combined with, for example, the Gurvits' algorithm generalized to include multiphotons to approximate the Fourier components of the molecular spectra with reduced costs in such situation within a reasonable error. The sampling may be performed in the particularly determined representation space as described in further detail below.

The present disclosure implies that Gaussian boson sampling itself is a hard task, but when it comes to the coarse-grained version of sampling, an efficient classical counterpart may exist. Therefore, on the contrary to the common understanding, the disclosure herein suggests that molecular vibronic spectra may not be the candidate for which only the power of a quantum sampler can boost the computational performance beyond classical means. Rather, classical algorithm as described above may diminish or reduce the quantum advantage.

On the other hand and as shown in further detail below, beyond Gaussian framework where a direct integral does not work, the disclosure herein shows that a Monte Carlo method may be inefficient when the number of quanta of the input state is large. When a similar problem in single-photon boson sampling is considered, computing the Fourier components is a #P-hard problem, which is in stark contrast to Gaussian boson sampling case. Nevertheless, a quantum-inspired classical efficient algorithm has been identified herein to approximate Fourier components of molecular vibronic spectra, which may be further applied to other application scenarios.

### Non-Sampling Classical Molecular Vibronic Spectra Computation

The transition probability between an initial vibronic mode and a certain final vibronic mode is referred to as the Franck-Condon (FC) factor. FC profiles (FCP) may be obtained by computing many FC factors corresponding to a given vibrational transition frequency (ω_{vib}). For example, the FC factor at 0 K may be obtained with the initial vacuum state as

$$FCP ( {ω}_{vib} ) = {\sum }_{m = 0}^{∞} {\vert 〈 m \vert {\hat{U}}_{Dok} \vert 0 〉 \vert}^{2} δ ( {ω}_{vib} - {ω}^{′} \cdot m ) , \qquad ( 1 )$$

where the Doktorov transformation Û_{Dok} is given by

Û_{Dok}=\hat{D}(δ/\sqrt{2})S_{Ω}^{\},\hat{R}_{U}Ŝ_{Ω}, (2)

where δ(·) represents the delta function and m=(m₁, . . . , m_{M}) is the final vibronic modes excitation vector with M vibronic modes. Here, Ŝ, \hat{D}, and \hat{R}ᵤ represent squeezing, displacement, and rotation operators, respectively, and Ω and Ω′ are given by

Ω≡diag(\sqrt{ω₁}, . . . ,\sqrt{ω_{M}}),Ω′≡diag(\sqrt{ω′₁}, . . . ,\sqrt{ω′_{M}}), (3)

where ωᵢ's and ωᵢ's account for initial and final harmonic angular frequencies, respectively.

The FCP above represents the molecular vibronic spectra. Eq. (1) shows that the direct computation of all FC factors are inevitably computational hard. In particular, not only is the number of combinations of m satisfying the delta function combinatorially large, the FC factor | [symbol] m|Û_{Dok}|0 [symbol] |² corresponds to the hafnian of a matrix, the computation of which costs exponentially in the size of matrix or a number of vibronic modes. For a fixed m=Σᵢ₌₁^{M}mᵢ, the number of FC factors may be given by

$$( \begin{matrix}M + m - 1 \\ m\end{matrix} ) . \qquad ( 4 )$$

### Gaussian Boson Sampling for Molecular Vibronic Spectra Generation via Quantum Simulation

Gaussian boson sampling represents one of the sampling problems that are proved hard for classical computers under some plausible assumptions. To implement Gaussian boson sampling, a product of M single-mode Gaussian states, |ψᵢₙ [symbol] , may first be prepared, and the product state may be fed into an M-mode linear-optical circuit Û_{LON}, composed of beam splitters. The output state |ψₒᵤₜ=Û_{LON}|ψᵢₙ [symbol] may be detected or measured by photon-number detectors.

The output photon patterns in may follow the probability distribution below

ρ(m)=| [symbol] m|Û_{LON}|ψᵢₙ [symbol] |², (5)

which may be related to the (loop) hafnian of a certain matrix.

Due to Gaussian boson samplings computational power beyond classical computers, a Gaussian boson sampler may be employed to generate molecular vibronic spectra. For example, the correspondence between the FC factor | [symbol] m|Û_{Dok}|0 [symbol] |² in Eq. (1) for zero temperature and the output probability ρ(m) of detection photon number pattern in in Gaussian boson sampling may be established with an appropriate choice of input state and the linear-optical operation.

In some implementations, an appropriate Gaussian boson sampling may always be chosen by exploiting the fact that the Doktorov operation Û_{Dok} is a Gaussian unitary, and can be decomposed as Û_{LON}\hat{D}(α)Ŝ(r)\hat{V}_{LON}. Since \hat{V}_{LON}|0 [symbol] =|0 [symbol] , the decomposed unitary operation can be implemented by preparing displaced squeezed states and applying a linear-optical circuit, which is exactly the procedure of Gaussian boson sampling. In other words, for the Doktorov operation Û_{Dok} of a molecular structure, a Û_{LON} can be identified and used to build the linear optical circuits. The linear operators above, may be mix of both position and momentum operators.

Therefore, by implementing Gaussian boson sampling and post-processing the output samples using the relation (1), FCP(ω_{vib}) may be efficiently generated via simulation by the linear optical quantum circuit, as shown by 120 of FIG. 1 and as described above.

More specifically, sampling may be first taken from ρ(m) using Gaussian boson sampler. A number of samples may be collected, represented by S={m⁽ⁱ⁾}ᵢ₌₁^{N}. The samples may then be sorted according to the delta function above with respect to the frequency (or energy). In some implementations, a window around each frequency Δω_{vib} may be introduced. The window may be provided with a predetermined and/or configurable size Δω_{vib}.

In other words, when a samples frequency ω′·m lies on [ω_{vib} Δω_{vib}/2,ω_{vib}+Δω_{vib}/2] for a certain ω_{vib}, a statistical bin corresponding to ω_{vib} may be incremented. Once sufficient number of samples are post-processed, an estimate of eFCP(ω_{vib}) (denoting empirical FCP, referring to the experimental quantum simulation aspect of the methodology) may be generated.

### Exact Quantum-Inspired Classical Solution for Molecular Vibronic Spectra at Zero Temperature

Inspired by the mapping from a molecular vibronic spectra problem to a Gaussian boson sampling and the phase-space method in quantum optics, the quantum-inspired solution for classically obtaining the molecular vibronic spectral without replying on a quantum mechanical simulation machine may be identified.

For example, it is noted that the Fourier components of the molecular vibronic spectra may be analytically derived and simplified as:

$$\tilde{G} ( k ) ≡ 〈 {⊗}_{i = 1}^{M} {\sum }_{{m}_{i} = 0}^{∞} \vert {m}_{i} 〉 〈 {m}_{i} {\vert}_{i} {e}^{- {ikm}_{i} {ω}_{i}^{′} θ} 〉 \qquad ( 6 )$$

$$= 〈 {e}^{- ik \hat{n} \cdot {ω}_{i}^{′} θ} 〉 \qquad ( 7 )$$

$$G ( {ω}_{vib} ) = \frac{1}{K + 1} {\sum }_{k} \tilde{G} ( k ) {e}^{ik θ {ω}_{vib}} \qquad ( 8 )$$

$$= {\sum }_{m = 0}^{∞} p ( m ) δ ( {ω}_{vib} - {ω}^{′} \cdot m ) , \qquad ( 9 )$$

where θ≡2π/(K+1), k∈{0, . . . , K}, K is the number of bins in discretized distribution of ω_{vib}, and |mᵢ [symbol] [symbol] mᵢ|ᵢ, is the projector on mᵢ, photon state for the ith mode.

The final expression above shows the exact correspondence between G(ω_{vib}) and FCP (ω_{vib}). Hence, in general, a Fourier component is an overlap between an output state |ψₒᵤₜ [symbol] and a phase-shifted state e^{-ikñ·w′θ}|ψₒᵤₜ [symbol] . Once such overlap is computed efficiently (e.g., in a classical manner), the Fourier components may then be obtained and used to recover the spectra by an inverse Fourier transform.

Especially when the relevant quantum states are Gaussian states, which is the case for molecular vibronic spectra at zero temperature to transition to thermal states, the Fourier components can be analytically computed. One example way to compute the Fourier components may involve using the positive P-representation of the Gaussian state in a phase space as described above.

More generally, a generalized P-representation of an M-mode quantum state may represent one of the quasi-probability distributions of a corresponding bosonic state of the molecular vibronic modes:

$$\hat{ρ} = {\int }_{{ℂ}^{2 M}} P ( α , β ) \hat{Λ} ( α , β ) d α d β , \hat{Λ} ( α , β ) ≡ \frac{\vert α 〉 〈 {β}^{*} \vert}{〈 {β}^{*} \vert α 〉} , \qquad ( 10 )$$

where |α [symbol] =|α₁ [symbol] ⊗ . . . ⊗|α_{M} [symbol] is an M-mode coherent state.

An important property of the generalized P-representation is that the distribution P(α, β) representing the bosonic state can always be chosen non-negative (hence positive P-representation), and the expectation value of a normal-ordered operator can be readily computed. Specifically, for molecular vibronic spectra generation, 2M complex numbers (α,β) may be sampled from the generalized P-representation of an input Gaussian state and the samples may be transformed by the linear-optical unitary operation U as (α,β)→(α′,β′)=(Uα, U*β), where U represents the trans-mission/transition matrix in the phase space. For the measurement portion of the analytics, the photon number operator \hat{n}ᵢ may be replaced with α′β′. For example, for the measurement outcome (m₁, m₂) for two modes, the corresponding observable may be written as |m₁ [symbol] [symbol] m₁|₁⊗|m₂ [symbol] [symbol] m₂|₂=: \hat{n}₁^{m}^{₁}e^{-\hat{n}}^{₁}/m₁!⊗\hat{n}₂^{m}^{₂}e^{-\hat{n}}^{₂}/m₂!:, so that the phase-space variable represented by (α′₁β′₁)^{m}^{₁}(α′₂β′₂)^{m}^{₂}e^{-α′}^{₁}^{β′}^{₁}^{-α′}^{₂}^{β′}^{₂}/m₁!m₂! may be obtained. Here, |j [symbol] [symbol] j|ᵢ represents the projector on j photon state for the ith mode, and :Ô: represents the normally ordered form of an operator Ô. For a sufficiently large number of samples, it may be guaranteed that for normal-ordered observables, the average converges to the expectation value for the output quantum state

For example, the positive P-representation for a single-mode squeezed state may be chosen as:

$$P ( α , β ) = \frac{\sqrt{1 + γ}}{π γ} {e}^{- ( {α}^{2} + {β}^{2} ) ( {γ}^{- 1} + 1 / 2 ) + αβ} , \qquad ( 11 )$$

where the domain is the real plane and γ≡e^{2r}−1 for a squeezing parameter r>0.

Using the positive P-representation of single-mode Gaussian states and the relation for a normal-ordered operator such as e^{-γ\hat{n}}=: e^{\hat{n}(e}^{^{−γ}}⁻¹⁾:, the Fourier components may be rewritten as:

$$\tilde{G} ( k ) = 〈 : exp [ {\sum }_{i = 1}^{M} {\hat{n}}_{i} ( {e}^{- ik {ω}_{i}^{′} θ} - 1 ) ] : 〉 \qquad ( 12 )$$

$$= {\int }_{{ℝ}^{2 M}} d α d β {P}_{in} ( α , β ) exp [ {\sum }_{i = 1}^{M} {α}_{i}^{′} {β}_{i}^{′} ( {e}^{- ik {ω}_{i}^{′} θ} - 1 ) ] , \qquad ( 13 )$$

where Pᵢₙ(α,β) is the positive P-representation of an input squeezed state. Here, :Ô: represents the normal-ordered form of an operator Ô, and (α′,β′)=(Uα,U*β) accounts for the linear-optical unitary operation.

More specifically, when a coherent state is processed through an M-mode linear-optical circuit, it is transformed as Û|α [symbol] =|Uα [symbol] , where U is the corresponding M×M unitary matrix for the circuit.

Since \acute{G}(k) is now written as a Gaussian integral, it can be analytically obtained, which is given by

$$\tilde{G} ( k ) = 𝒩 \frac{{( 2 π )}^{M}}{\sqrt{det ( Q )}} exp ( \frac{1}{2} {c}^{T} {Q}^{- 1} c + {c}_{0} ) , \qquad ( 14 )$$

$$where {ϕ}_{j} = - k θ {ω}_{j} ,$$

$$Q ≡ ( \begin{matrix}2 {Γ}^{- 1} + {M}_{} & - {U}^{T} {diag ( {e}^{i {ϕ}_{j}} )}_{j = 1}^{M} {U}^{*} \\ - {U}^{†} {diag ( {e}^{i {ϕ}_{j}} )}_{j = 1}^{M} U & 2 {Γ}^{- 1} + {M}_{}\end{matrix} ) , and , \qquad ( 15 )$$

$$𝒩 ≡ {\prod }_{i = 1}^{M} \frac{\sqrt{1 + {γ}_{i}}}{π {γ}_{i}} , Γ ≡ {diag ( {γ}_{i} )}_{i = 1}^{M} , Φ = {diag ( {e}^{i {ϕ}_{j}} - 1 )}_{j = 1}^{M} , \qquad ( 16 )$$

$$c ≡ {( {a}^{T} , {b}^{T} )}^{T} , a ≡ \frac{{U}^{T} Φ δ}{\sqrt{2}} , b ≡ \frac{{U}^{T} Φ δ}{\sqrt{2}} , {c}_{0} ≡ \frac{{δ}^{T} Φ δ}{2} .$$

Here, δ represents a real vector accounting for the displacement in the Doktorov transformation (see Eq. (2)). More detailed derivation above and proof of the convergence of the integral are further provided later in this disclosure.

It implies that Fourier components of the molecular vibronic spectra at zero temperature have a solution. As such, the spectra may be obtained by simply taking the inverse Fourier transform, thereby avoiding having to use a quantum simulator to generate the molecular vibronic spectra.

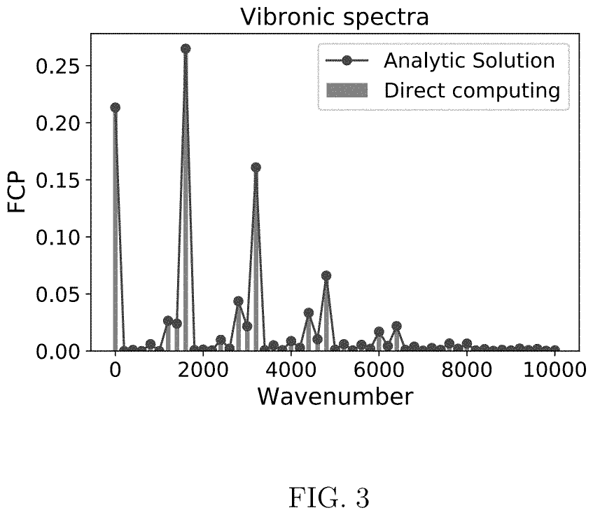

As an example, FIG. 3 shows a comparison between an analytical solution of an example molecular vibronic spectra based on the formalism above and direct classical computation. FIG. 3 shows that the analytical solution based on the Fourier formalism above matches with the spectra obtained by directly computing probabilities. For the analytical solution, the Fourier components are first computed using Eq. (14) followed by the inverse Fourier transform to obtain the spectra. The corresponding Doktorov transformation is determined in accordance with the simulated molecular system being CH₂O₂, 1¹A′→1²A′. The number of samples processed in FIG. 2 is N=10⁴. An increase of number of bins in the frequency domain may be achieved with a polynomial computational cost.

### Exact Solution for Molecular Vibronic Spectra at Finite Temperature

The same method above may be applied to initial states of the molecular system at finite temperatures. Specifically, in some example implementations, the quantum-inspired classical approach to the generation of molecular vibronic spectra may be further applied to finite temperatures other than zero temperatures.

At finite temperature T, the molecular vibronic spectra may be written as

$$FCP ( {ω}_{vib} ) = {\sum }_{n , m = 0}^{∞} p ( n , m ) δ ( {ω}_{vib} - ( {ω}^{′} \cdot m - ω \cdot n ) ) , where \qquad ( 17 )$$

$$p ( n , m ) = {p}_{T} ( n ) {\vert 〈 n \vert {\hat{U}}_{Dok} \vert m 〉 \vert}^{2} . \qquad ( 18 )$$

Here, p_{T}(n)≡ [symbol] n|\hat{ρ}_{T}|n [symbol] is the probability of photon number |n [symbol] from an M-mode thermal state \hat{ρ}_{T} at temperature T.

In some specific implementations, a Gaussian boson sampling quantum procedure described above may be correspondingly constructed for the finite temperature situations. For example, M auxiliary modes may be determined and added to the quantum simulation. Two-mode squeezed states may be further prepared to simulate thermal states. The photon numbers in the additional modes may be detect as well. The process is exemplary depicted in FIG. 4. Inspired by such quantum simulation, a classical sampling algorithm of Fourier components in the P-representation similar to the zero-temperature situation may also be employed with an addition of the auxiliary modes.

In such example implementations, the original M modes output photons correspond to in and the additional M modes' output photons corresponds to n. Therefore, the same framework described above for zero temperature may be employed to obtain the solution for molecular vibronic spectra at finite temperature, as illustrated in FIG. 4, showing a comparison of state transform between zero-temperature scenario and the finite temperature scenario.

For example, the FCP of the molecular system at the finite temperature may be rewritten as:

$$FCP = {\sum }_{m , n = 0}^{∞} {\vert 〈 m , n \vert {\hat{U}}_{Dok}^{′} \vert 0 〉 \vert}^{2} δ ( {ω}_{vib} - ( {ω}^{′} \cdot m - ω \cdot n ) ) , \qquad ( 19 )$$

which is the same form as Eq. (1) except for the negative part in the delta function. Here, Û′_{Dok}=Û_{Dok}Û_{TMSO} is obtained by adding two-mode squeezing operators. The term “TMSO” denotes “Two-Mode-Squeezing Operator”. Each pair of two modes include an original mode and an auxiliary mode.

Again, the Fourier transform of the FCP at finite temperature may be given by

\tilde{G}(k)= [symbol] e^{-ik\hat{n}·ω″θ} [symbol] , (20)

where ω″=(ω′^{T}, −ω^{T})^{T}. Therefore, the analytic solution for Fourier components can thus be found for the molecular system at a finite temperature. The vibronic spectra at the finite temperature thus may be estimated by inverse Fourier transform of the analytically generated Fourier components above.

### Molecular Vibronic Spectra for Non-Gaussian Initial State

The above implementations assume a vacuum or otherwise a thermal or Gaussian initial state for the molecular vibronic modes. In a more general case, for example, the molecular system may be in a non-thermal initial state. In such circumstances, the molecular vibronic system may not be described by Gaussian states.

In a particular circumstance, the initial state of the molecular vibronic system may be a Fock state or number state of the vibronic, |n [symbol] , rather than vacuum |0 [symbol] a Gaussian state. For optical processes including the single vibronic level fluorescence and the resonance Raman scattering, for example, a spectra from specific vibronic levels needs to be analyzed, instead of a thermal distribution or a ground state. Indeed, a quantum simulation of such a process has also been experimentally implemented for various photoelectron processes such as photodetachment of ozone anion. In these cases, the FCP of the molecular vibronic system for such a non-Gaussian initial state may be expressed as:

$$FCP ( {ω}_{vib} ) = {\sum }_{m = 0}^{∞} {\vert 〈 m \vert {\hat{U}}_{Dok} \vert n 〉 \vert}^{2} δ ( {ω}_{vib} - {ω}^{′} \cdot m ) , \qquad ( 21 )$$

$$\tilde{G} ( k ) = 〈 n \vert {\hat{U}}_{Dok}^{†} {e}^{- ik \hat{n} \cdot {ω}^{′} θ} {\hat{U}}_{Dok} \vert n 〉 = 〈 n \vert \hat{V} \vert n 〉 , \qquad ( 22 )$$

where \hat{V}≡Û_{Dok}^{†}e^{-k\hat{n}·w′θ}Û_{Dok} is a Gaussian unitary operation. Using Bloch-Messiah decomposition, the Gaussian unitary operation is decomposed as \hat{V}=\hat{D}(ξ)Ûₗᵢₙ₂Ŝ(r)Ûₗᵢₙ₁. Because of the non-Gaussian initial state, the spectra cannot be directly mapped to a Gaussian boson sampling and so it may require a non-Gaussian type of boson sampling.

In some implementations, the Fourier components can be written as a loop hafnian of a matrix:

$$\tilde{G} ( k ) = \frac{lhaf ( {\tilde{Σ}}_{n} )}{n ! Z} , where \qquad ( 23 )$$

$$Σ ≡ ( \begin{matrix}{U}_{lin 2} tanh {rU}_{lin 2}^{T} & {U}_{lin 2} sech {rU}_{lin 1} \\ {U}_{lin 1}^{T} sech {rU}_{lin 2}^{T} & - {U}_{lin 1}^{T} tanh {rU}_{lin 1}\end{matrix} ) \qquad ( 24 )$$

is an 2M×2M complex symmetric matrix,

$$Ϛ ≡ ( \begin{matrix}- {U}_{lin 2} tanh {rU}_{lin 2}^{T} \cdot {ξ}^{*} + ξ \\ - {U}_{lin 1}^{T} sech r {U}_{lin 2}^{T} \cdot {ξ}^{*}\end{matrix} ) \qquad ( 25 )$$

is an 2M-dimensional vector, and

$${Z}^{- 1} ≡ 〈 0 \vert \hat{V} \vert 0 〉 = \frac{{e}^{\frac{1}{2} {ξ}^{T} \cdot Σ \cdot ξ}}{\sqrt{{\prod }_{i = 1}^{M} cosh {r}_{i}}} , \qquad ( 26 )$$

is the normalization factor, which is the same as the Fourier components of molecular vibronic spectra at zero temperature.

Here, \tilde{Σ}ₙ is obtained by first replacing the diagonal elements of Σ by ζ to obtain \tilde{Σ} and repeating ith row and column of each block matrix of \hat{Σ}nᵢ, times, and is thus an n×n matrix with n≡Σᵢ₌₁^{M}nᵢ. Therefore, computing the Fourier components reduces to computing loop hafnians of n×n complex symmetric matrices.

Loop hafnian is a quantity that is related to perfect matchings of a graph including loops (hafnian does not allow loops). The best-known algorithms computational cost of computing a loop hafnian is O(n³2^{n/2}) with n being the matrix size. Thus, if FC factors, which is written as a loop hafnian of a matrix whose size is n+m is to be directly computed to obtain FC profiles in Eq. (1), then the complexity would be exponential in (n+m)/2. On the other hand, the complexity of computing the Fourier components in the proposed method relies on the input photons n rather than the output photons m and the system size, i.e., the proposed method can be efficiently implemented as long as n is small enough. More precisely, since the redundancy of rows and columns for nᵢ≥2 does not increase the complexity of computing a loop hafnian because it does not increase the rank of the matrix, the important factor for complexity is the number of nonzero elements of n.

Meanwhile, computing the loop hafnian of a general complex symmetric matrix in multiplicative error is known to be #P-hard. It implies that computing the Fourier components of general molecular vibronic spectral with Fock state inputs and squeezing is also #P-hard. More formally, an arbitrary complex matrix may be embedded into a submatrix of a unitary matrix with an appropriate normalization so the corresponding spectra generation problem reduces to computing a permanent, which is #P-hard. The unitary matrix for Fourier coefficient is written as Ûe^{i\hat{n}·ω}Û^{†}, which is a diagonalized form of arbitrary unitary matrix, as shown further below.

Therefore, the Fourier components for molecular vibronic spectra mapped to Gaussian boson sampling have an analytic solution while the corresponding problem for non-Gaussian cases is a computationally hard problem, which presents a separation between Gaussian boson sampling and non-Gaussian type of boson sampling such as single-photon boson sampling. The Fourier components reduce to hafnian and permanent when there is no displacement or squeezing, respectively.

Even if a boson sampling experiment is performed using a quantum device the spectra is reproduced from the outcomes, estimation of the spectra has an additive error depending on the number of samples. Therefore, reproducing the spectra within a multiplicative error is not expected to be achieved by running a boson sampling circuit, so an additive error is the relevant quantity using a classical simulation to compare with a quantum device.

### Fock States: Sampling Using Positive P-Representation

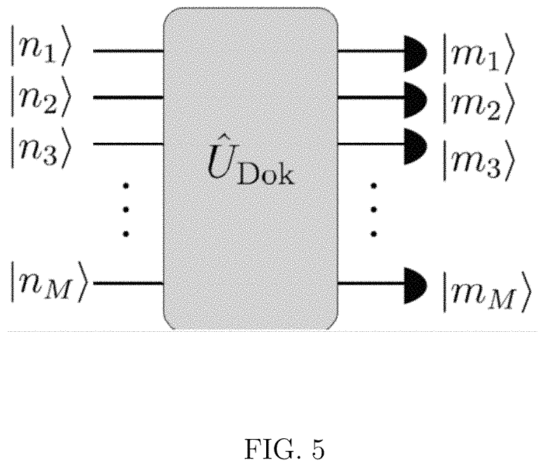

To employ a mapping from molecular vibronic spectra to Gaussian boson sampling, again, additional M modes and two-mode squeezed states of squeezing parameters si may be introduced, as illustrated in FIG. 5, which shows an comparison between Gaussian boson sampling for a thermal state, and mapping to Gaussian sampling for a Fock state. The difference from the finite temperature case above is that now the outcome n for the additional modes need to be post-selected.

Thus, the corresponding FCP can be written as

$$G ( {ω}_{v i b} ) = \frac{1}{N ( n )} {\sum }_{m = 0}^{∞} p ( m , n ) δ ( {ω}_{v i b} - {ω}^{′} \cdot m ) , \qquad ( 27 )$$

where [symbol] is the normalization due to the post-selection,

$$𝒩 ( n ) = {\prod }_{i = 1}^{M} \frac{{tanh}^{2 {n}_{i}} {s}_{i}}{{cosh}^{2} {s}_{i}} , \qquad ( 28 )$$

and p(m, n)= [symbol] (n) [symbol] m|Û_{Dok}|n [symbol] ².

Its Fourier components are given by

$$\tilde{G} ( k ) = \frac{1}{𝒩} 〈 {e}^{- ik θ {\sum }_{j = 1}^{M} {\hat{n}}_{j} {ω}_{j}^{′}} ⊗ \vert n 〉 〈 n \vert 〉 . \qquad ( 29 )$$

### Approximation of Hafnian

In some implementations, another method is to use the expression in Eq. (23). Assume that the displacement is zero, the loop hafnian in Eq. (23) then reduces to a hafnian. In this case, a randomized algorithm is constructed to estimate a hafnian of an n×n complex symmetric matrix Σ using the equality

$$haf ( Σ ) = {𝔼}_{υ ∈ {\{ 0 , 1 \}}^{n}} [ {( - 1 )}^{{\sum }_{i = 1}^{n} {υ}_{i}} \frac{{2}^{n / 2}}{( n / 2 ) !} {( {h}^{T} Σ h )}^{n / 2} ] , \qquad ( 30 )$$

where [symbol] _{Σ}[·] is the average over the normal distribution of covariance matrix Σ, and h=(½−v₁, . . . , ½−v_{M})^{T} and n is even (otherwise the hafnian is zero).

Therefore, by sampling v∈{0,1}ⁿ uniformly and averaging over the samples, the hafnian may be estimated, which, together with the fact that ∥Σ∥=1 in Eq. (24), leads to the bound for estimate q of a Fourier component as

$$Pr [ \vert q - \frac{haf ( {Σ}_{n} )}{Z n !} \vert ≳ ϵ \frac{{e}^{n / 2}}{\sqrt{π n} Z} ] \leq 2 {e}^{- N {ϵ}^{2} / 2} , \qquad ( 31 )$$

where Z=\sqrt{Πᵢ₌₁ⁿ cosh rᵢ} and N is the number of samples. Thus, if Πᵢ₌₁ⁿ cosh rᵢ>eⁿ, the estimation error is smaller than e with exponentially small failure probability if the number of samples is chosen as N=O(1/ϵ²).

It suggests that if the condition is satisfied, classically estimating the Fourier components and taking the inverse Fourier transformation renders the same scaling of precision to running a boson sampling circuit.

For nonzero displacement and loop hafnian, although there is a similar equality as in Eq. (30), the resultant error bound is more complicated than hafnian.

It is further provided another method of estimating a loop hafnian that uses the integral representation of loop hafnian in Methods. Since loop hafnian corresponds to the high order moment of multivariate normal distribution, loop hafnian of an n×n complex symmetric matrix \tilde{Σ} may be written as an integral:

$$lhaf ( \tilde{Σ} ) = \frac{1}{{π}^{4 n}} {\int }_{{ℂ}^{4 n}} d α d γ d ω d β {\prod }_{i = 1}^{n} [ ( {α}_{i} + {ξ}_{i} + {ζ}_{i}^{α} ) {( {β}_{i} + {ζ}_{i}^{{β}^{*}} )}^{*} ] \times exp ( - \frac{1}{2} {υ ( α , β , γ , ω )}^{T} \cdot {Σ}^{- 1} \cdot υ ( α , β , γ , ω ) ) . \qquad ( 32 )$$

The expression is obtained in the section below entitled “Approximation algorithm of hafnian’,’ where the explicit definition of each term is given. Therefore, the loop hafnian can be estimated by decomposing the exponential term into an imaginary part and a real part, which follows the normal distribution, and, by sampling from the normal distribution and averaging over the random variable including the imaginary part.

### Fock States: Approximation of Fourier Components of Molecular Vibronic Spectra

The observation that the additive error is the achievable error from running a quantum device, some classical algorithms that might be potentially able to efficiently estimate the Fourier components within an additive error may be conceived.

For example, Gurvits's algorithm can efficiently approximate the corresponding quantity within an additive error e in single-photon boson sampling, where the FCP is written as permanent of a submatrix of a unitary matrix (see the section entitled “Computing Fourier components of vibronic spectra for single-photon input cases” below). Indeed, if a boson sampling is directly run to obtain the FCP, the Chernoff bound poses a limitation of accuracy, which is given by O(1/poly(N)) when the number of samples is N. It suggests that even though exactly computing the Fourier components might be difficult, it may be possible to efficiently approximate them within a reasonable additive error.

Since inverse Fourier transformation does not amplify the additive error of Fourier components, if there is an efficient algorithm that approximates the Fourier components within an error e in a running time O(poly(1/ϵ)), the algorithm may allow for achieving a similar accuracy as running a boson sampling.

Fock-State: Estimating Fourier Components of Spectra with Boson Sampling with Generalized Gurvits' Algorithm

For Fock-state boson sampling, the Fourier components can be written as

$$\tilde{G} ( k ) = 〈 n \vert {\hat{U}}^{†} {e}^{- ik θ \hat{n} \cdot ω} \hat{U} \vert n 〉 ≡ 〈 n \vert V \vert n 〉 = \frac{Per ( {V}_{n , n} )}{n !} , \qquad ( 33 )$$

where a unitary operator \hat{V} is defined as \hat{V}≡Û^{†}e^{-k\hat{n}·ωθ}Û, consisting of Û and a phase-shift operator e^{-ik\hat{n}·wθ} and Û^{†}.

Thus, it is a linear-optical circuit characterized by a unitary matrix V=U^{†}DU, with D≡diag(e^{-ikθω}^{₁}, . . . , e^{-ikθω}^{_{M}}) characterizing the phase-shift operator. Here, such a diagonal form suggests that V is a general form of an arbitrary unitary matrix. Together with this fact, since computing the permanent of a general matrix in multiplicative error is #P-hard and one can embed an arbitrary complex matrix into a submatrix of a unitary matrix by normalizing the matrix, computing its Fourier component in multiplicative error is also #P-hard. Therefore, it shows that computing Fourier components in multiplicative error is a #P-hard problem, and consequently, it proves that the exact computation of the spectra is also a #P-hard problem.

In fact, it is noted that even if a boson sampling experiment runs using a quantum device and reproduces the spectra from the sampling outcomes, the resultant spectra has an additive sampling error. Therefore, reproducing the spectra within a multiplicative error is not expected to be achievable by running a boson sampling circuit with polynomially many samples. As such, an additive error is a relevant target using a classical simulation to compare with a quantum device.

Interestingly, there exists a classical algorithm, the so-called Gurvits' algorithm, which can efficiently approximate the permanent of a matrix within an additive error. However, this algorithm is not sufficient for general Fock-state boson sampling cases where nᵢ contains more than a single-photon for some i's because the error can increase exponentially in the system size in that case (described in further detail below). The Gurvits' algorithm, however, may be modified to estimate the spectra which includes multiphotons n using the following equality (see detailed derivation in the next section):

$$\frac{Per ( {V}_{n , n} )}{n !} = {𝔼}_{x ∈ 𝒳} [ {\prod }_{i = 1}^{M} {( \frac{{{\overline{y}}_{i} ( Vy )}_{i}}{{n}_{i}} )}^{{n}_{i}} ] , \qquad ( 34 )$$

where yᵢ≡\sqrt{nᵢ}xᵢ, x∈ [symbol] ≡ [symbol] [n₁+1]× . . . × [symbol] [n_{M}+1], where [symbol] [j] is the set of jth roots of unity.

Thus, by sampling the random variable with uniform x∈ [symbol] , the randomized algorithm gives an estimate μ of permanent of an n×n matrix such that

$$\vert \frac{Per ( {V}_{n , n} )}{n !} - μ \vert < ϵ {‖ V ‖}^{n} , \qquad ( 35 )$$

with high probability 1−δ with running time T=O(poly(n, 1/ϵ, log δ⁻¹)). Here, ∥V∥ is the spectral norm of the matrix V, which is always 1 for this case because V is a unitary matrix.

Thus, the modified (or generalized) Gurvits' algorithm enables an efficiently approximation of Fourier components within a reasonable additive error even though computation of the Fourier components in a multiplicative error is hard (#P-hard). Note that although a modified or generalized Gurvits' algorithm might be used to approximate individual probabilities in Eq. (9), it is nontrivial to approximate the sum of exponentially many probabilities, which is enabled by approximating Fourier components instead of probabilities.

The remaining challenge is the propagation of the error of Fourier coefficients to that of the spectra through the inverse Fourier transformation. Using Parseval's relation, we prove that as long as we estimate the Fourier coefficients with a small error ϵ, the transformed spectra's error is also small as ϵ:

$${\sum }_{Ω = 0}^{{Ω}_{max}} {\vert Δ G ( Ω ) \vert}^{2} = \frac{1}{{Ω}_{max} + 1} {\sum }_{k = 0}^{{Ω}_{max}} {\vert Δ G ( k ) \vert}^{2} \leq {ϵ}^{2} , \qquad ( 36 )$$

which proves that |ΔG(Ω)|≤ϵ for any Ω, where ΔG and Δ\tilde{G} represent the error of spectra and Fourier component estimation.

Hence, if there is an efficient algorithm that approximates the Fourier components within an error e in a running time T=O(poly(M, 1/ϵ, log δ⁻¹)), the algorithm enables us to achieve the same accuracy as running a boson sampling. For Fock-state boson sampling case, Gurvits's algorithm is evidently such an algorithm estimating Fourier components. Consequently, we have shown that the molecular vibronic spectra problem corresponding to Fock-state boson sampling can be efficiently solved by a classical computer as accurately as running a boson sampler, which indicates that there is no quantum advantage from this problem.

Gurvits' Algorithm with Repeated Rows and Columns

The disclosure below first presents the original Gurvits's algorithm and generalized algorithm to improve the bound when rows and columns are repeated. The Gurvits's algorithm exploits the following equality:

$$Per ( X ) = {𝔼}_{x ∈ {\{ - 1 , 1 \}}^{n}} [ {\prod }_{i = 1}^{n} ( {\sum }_{j = 1}^{n} {x}_{i} {X}_{ij} {x}_{j} ) ] . \qquad ( 37 )$$

Thus, by sampling the random variable with uniform x∈{−1, 1}ⁿ, the randomized algorithm gives an estimate μ of permanent of an n×n matrix X such that

|Per(X)−μ|<ϵ∥X∥ⁿ, (38)

with high probability 1−δ with running time T=O(poly(n, 1/ϵ, log δ⁻¹)).

When a submatrix of a unitary matrix is considered, this expression is sufficient because the submatrix's norm is bounded by 1. However, when the rows and columns in X from a unitary matrix are repeated, which is the case when dealing with multiphoton inputs, the norm ∥X∥ is not generally bounded by 1. Therefore, the upper bound of the error can increase as ∥X∥ⁿ, i.e., exponentially in n. To deal with such multiphoton cases with a reduced error, Gurvits's algorithm may need to be generalized. Note that although the Gurvits's algorithm for multiphoton outputs may be generalized, i.e., Per(V_{n,m})= [symbol] n|\hat{V}|m [symbol] , where n∈{0, 1}ⁿ and in is a nonnegative integer vector, that is not sufficient for the purpose of handling multiphoton input and output, i.e., [symbol] n|\hat{V}|n [symbol] =Per (V_{n,n}).

Consider a case where the goal is to approximate a quantity

$$\frac{Per}{n !} , \qquad ( 39 )$$

where A∈ [symbol] ^{n×n} which is obtained by repeating ith row and column of a matrix B∈ [symbol] ^{k×k} for nᵢ times. Here, n∈ [symbol] _{≥0}^{k} with Σᵢ₌₁^{k} nᵢ=n. Further define a random variable

$${GenGly}_{x} ( A ) ≡ \frac{1}{{\prod }_{i = 1}^{k} {n}_{i}^{{n}_{i}}} {\prod }_{i = 1}^{k} {\overline{y}}_{i}^{{n}_{i}} {\prod }_{i = 1}^{k} {( {y}_{i} {B}_{i , 1} + … + {y}_{k} {B}_{i , k} )}^{{n}_{i}} = {\prod }_{i = 1}^{k} {( \frac{{{\overline{y}}_{i} ( By )}_{i}}{{n}_{i}} )}^{{n}_{i}} , \qquad ( 40 )$$

where γᵢ≡nᵢ^{1/2}xᵢ. Here, x∈ [symbol] [n₁+1]× . . . × [symbol] [nₖ+1]≡ [symbol] , where [symbol] [j] is the set of jth roots of unity. Then, its absolute value is given as

$$\vert {GenGly}_{x} ( A ) \vert = {( {\prod }_{i = 1}^{k} {n}_{i}^{{n}_{i}} )}^{- 1 / 2} \vert {\prod }_{i = 1}^{k} {( {y}_{i} {b}_{i , 1} + … + {y}_{k} {b}_{i , k} )}^{{n}_{i}} \vert = {( {\prod }_{i = 1}^{k} {n}_{i}^{{n}_{i}} )}^{- 1 / 2} \vert {\prod }_{i = 1}^{k} {c}_{i}^{{n}_{i}} \vert , \qquad ( 41 )$$

where cᵢ≡γ₁B_{i,1}+ . . . +γₖB_{i,k}. Now, let us find its upper bound, which determines the error of the corresponding randomized algorithm by Chernoff bound. First, we have a constraint

$${\sum }_{i = 1}^{k} {\vert {c}_{i} \vert}^{2} = {\sum }_{i = 1}^{k} {\vert {( By )}_{i} \vert}^{2} \leq {‖ B ‖}^{2} {‖ y ‖}^{2} = n {‖ B ‖}^{2} . \qquad ( 42 )$$

Further considering:

$$log {\prod }_{i = 1}^{k} {\vert {c}_{i} \vert}^{{n}_{i}} = {\sum }_{i = 1}^{k} {n}_{i} log \vert {c}_{i} \vert . \qquad ( 43 )$$

Using lagrange multiplier, with a constraint Σᵢ₌₁^{k}|cᵢ|²=c,

$$Z ≡ {\sum }_{i = 1}^{k} {n}_{i} log \vert {c}_{i} \vert - λ ( {\sum }_{i = 1}^{k} {\vert {c}_{i} \vert}^{2} - c ) , \qquad ( 44 )$$

It may be obtained that:

$$\frac{\partial Z}{\partial \vert {c}_{i} \vert} = \frac{{n}_{i}}{\vert {c}_{i} \vert} = 2 λ \vert {c}_{i} \vert = 0 , ∀ i . \qquad ( 45 )$$

Using the constraint Eq. (42),

$${\sum }_{i = 1}^{k} {\vert {c}_{i} \vert}^{2} = {\sum }_{i = 1}^{k} \frac{{n}_{i}}{2 λ} = \frac{n}{2 λ} = c , \qquad ( 46 )$$

the solution is obtained as

$$\vert {c}_{i} \vert = \sqrt{\frac{{n}_{i}}{2 λ}} = \sqrt{\frac{{cn}_{i}}{n}} . \qquad ( 47 )$$

Therefore, using the solution, we have an upper bound as

$${\prod }_{i = 1}^{k} {\vert {c}_{i} \vert}^{{n}_{i}} \leq exp ( {\sum }_{i = 1}^{k} {n}_{i} log \sqrt{\frac{{cn}_{i}}{n}} ) = {\prod }_{i = 1}^{k} {{n}_{i}^{{n}_{i} / 2} ( \frac{c}{n} )}^{n / 2} \leq {\prod }_{o = 1}^{k} {n}_{i}^{{n}_{i} / 2} {‖ B ‖}^{n} . \qquad ( 48 )$$

Hence, there is an upper bound of the absolute value of the random variable,

$$\vert {GenGly}_{x} ( A ) \vert = {( {\prod }_{i = 1}^{k} {n}_{i}^{{n}_{i}} )}^{- 1 / 2} \vert {\prod }_{i = 1}^{k} {c}_{i}^{{n}_{i}} \vert \leq {‖ B ‖}^{n} . \qquad ( 49 )$$

Next, it may be proved that the average of the random variables gives an unbiased estimator of Per(A)/n!, i.e.,

$$\begin{matrix}{𝔼}_{𝕩 ∈ χ} [ {GenGly}_{x} ( A ) ] = \frac{Per ( A )}{n !} . \\ First , & ( 50 ) \\ {𝔼}_{𝕩 ∈ χ} [ \frac{1}{{\prod }_{i = 1}^{k} {n}_{i}^{{n}_{i}}} {\prod }_{i = 1}^{k} {\overline{y}}_{i}^{{n}_{i}} {\prod }_{i = 1}^{k} {( {y}_{1} {B}_{i , 1} + ⋯ + {y}_{k} {B}_{i , k} )}^{{n}_{i}} ] & ( 51 ) \\ = \frac{1}{{\prod }_{i = 1}^{k} {n}_{i}^{{n}_{i}}} {𝔼}_{𝕩 ∈ χ} [ {\prod }_{i = 1}^{k} {{\overline{y}}_{i}^{{n}_{i}} ( {y}_{1} , {B}_{i , 1} + ⋯ + {y}_{k} {B}_{i , k} )}^{{n}_{i}} ] & ( 52 ) \\ = \frac{1}{{\prod }_{i = 1}^{k} {n}_{i}^{{n}_{i}}} {\sum }_{{σ}_{1} , … , {σ}_{n} ∈ [ k ]} ( {\prod }_{i = 1}^{k} {B}_{i , {σ}_{i}} ) {𝔼}_{𝕩 ∈ χ} [ {\prod }_{i = 1}^{k} {\overline{y}}_{i}^{{n}_{i}} {\prod }_{i = 1}^{n} {y}_{{σ}_{i}} ] , & ( 53 )\end{matrix}$$

where by the symmetry over the roots of unity,

$${𝔼}_{𝕩 ∈ χ} [ {\prod }_{i = 1}^{k} {\overline{y}}_{i}^{{n}_{i}} {\prod }_{i = 1}^{n} ] = 0 , \qquad ( 54 )$$

unless the product insides is equal to Πᵢ₌₁^{k}|γᵢ|²ⁿ^{ᵢ}, in which case it may be derived that

$${𝔼}_{𝕩 ∈ χ} [ {\prod }_{i = 1}^{k} {\overline{y}}_{i}^{{n}_{i}} {\prod }_{i = 1}^{n} ] = {\prod }_{i = 1}^{k} {n}_{i}^{{n}_{i}} . \qquad ( 55 )$$

Hence,

$${𝔼}_{𝕩 ∈ χ} [ {GenGly}_{x} ( A ) ] = {\sum }_{{t}_{1} … , {t}_{k} ∈ [ k ] : \vert \{ i : {t}_{i} = j \} \vert = {n}_{j} ∀ j ∈ [ k ]} {\prod }_{i = 1}^{k} {B}_{i , {t}_{i}} = \frac{Per ( A )}{n !} , \qquad ( 56 )$$

where n! appears to take into account the fact that each produce Πᵢ₌₁^{k}b_{i,t}_{ₖ} appears n! times.

Therefore, GenGlyₓ(A) gives us an unbiased estimator of Per(A)/n!, and the random variables are bounded by ∥B∥ⁿ. Due to the Chernoff bound, the randomized algorithm with number of samples N=O(1/ϵ²) provides an estimate μ with high probability 1−δ such that

$$\vert \frac{Per ( A )}{n !} - μ \vert < ϵ {‖ B ‖}^{n} . \qquad ( 57 )$$

### More Details of Exact Solution of Fourier Components of Molecular Vibronic Spectra

A detailed derivation of the analytic solution of Fourier components of the vibronic spectra is described below.

The initial positive P-representation above may be represented by:

$$\begin{matrix}{P}_{in} ( α , β ) = {\prod }_{i = 1}^{M} [ \frac{\sqrt{1 + {γ}_{i}}}{{πγ}_{i}} exp ( - ( {α}_{i}^{2} + {β}_{i}^{2} ) ( {γ}_{i}^{- 1} + 1 / 2 ) + {α}_{i} {β}_{i} ) ] & ( 58 ) \\ = 𝒩 exp [ - α \cdot A \cdot α - β \cdot B \cdot β - α \cdot C \cdot β - β \cdot {C}^{T} \cdot α ] , & ( 59 )\end{matrix}$$

where

$$A ≡ {diag ( {γ}_{i}^{- 1} + 1 / 2 )}_{i = 1}^{M} , B ≡ {diag ( {γ}_{i}^{- 1} + 1 / 2 )}_{i = 1}^{M} , C ≡ - 1 / 2 , 𝒩 ≡ {\prod }_{i = 1}^{M} \frac{\sqrt{1 + {γ}_{i}}}{{πγ}_{i}} . \qquad ( 60 )$$

Here, α and β are real M-dimensional vectors. In the disclosure above, the expression of the Fourier components of molecular vibronic spectra has been found as:

\tilde{G}(k)= [symbol] e^{-ikθ\hat{n}·w′} [symbol] , (61)

where the expectation value is over the output state of Gaussian boson sampling.

By using the relation e^{-γ\hat{n}}=: e^{\hat{n}(e}^{^{−γ−1)}}:, the operators can be written in a normal-ordered form and the Fourier transform may have the following property:

$$\begin{matrix}\tilde{G} ( k ) = {\sum }_{{ω}_{0} = 0}^{K} {\sum }_{m = 0}^{∞} p ( m ) δ ( {ω}_{0} - ω \cdot m ) {e}^{- ik {θω}_{0}} & ( 62 ) \\ = {\sum }_{m = 0}^{∞} p ( m ) {e}^{- ik θω \cdot m} & ( 63 ) \\ = 〈 {⊗}_{i = 1}^{M} {\sum }_{{m}_{i} = 0}^{M} \vert {m}_{i} 〉 〈 {m}_{i} \vert {e}^{- ik {θω}_{i} {m}_{i}} 〉 & ( 64 ) \\ = 〈 {⊗}_{i = 1}^{M} {\sum }_{{m}_{i} = 0}^{M} \vert {m}_{i} 〉 〈 {m}_{i} \vert {e}^{- ik {θω}_{i} {\hat{n}}_{i}} 〉 & ( 65 ) \\ = 〈 {⊗}_{i = 1}^{M} {e}^{- ik {θω}_{i} {\hat{n}}_{i}} 〉 & ( 66 ) \\ = 〈 : exp [ {\sum }_{i = 1}^{M} {\hat{n}}_{i} ( {e}^{- {ikw}_{i} θ} - 1 ) ] : 〉 , & ( 67 )\end{matrix}$$

where θ=2π/(K+1). For the last equality, we have used the relation e^{-γ\hat{n}}=: e^{\hat{n}(e}^{^{−γ}}⁻¹⁾:.

The expectation value may be computed as:

$$\tilde{G} ( k ) = 〈 : exp [ {\sum }_{i = 1}^{M} {\hat{n}}_{i} ( {e}^{i {ϕ}_{i}} - 1 ) ] : 〉 = {〈 exp [ {\sum }_{i = 1}^{M} {α}_{i}^{′} {β}_{i}^{′} ( {e}^{i {ϕ}_{i}} - 1 ) ] 〉}_{P} \qquad ( 68 )$$

$$= {〈 exp [ {\sum }_{i = 1}^{M} ( {\sum }_{j = 1}^{M} {U}_{ij} {α}_{j} + {α}_{0 i} ) ( {\sum }_{k = 1}^{M} {U}_{ik}^{*} {β}_{k} + {β}_{0 i} ) ( {e}^{i {ϕ}_{i}} - 1 ) ] 〉}_{P} \qquad ( 69 )$$

$$= {〈 exp [ α \cdot 𝒰 \cdot β + a \cdot α + b \cdot β + {c}_{0} ] 〉}_{P} \qquad ( 70 )$$

$$= 𝒩 \int d α d β exp [ - α \cdot A \cdot α - β \cdot B \cdot β - α \cdot \tilde{C} \cdot β - β \cdot {\tilde{C}}^{T} \cdot α + a \cdot α + b \cdot β + {c}_{0} ] \qquad ( 71 )$$

$$= 𝒩 \int dq exp [ - q \cdot Q \cdot q / 2 + c \cdot q + {c}_{0} ] , \\ where {ϕ}_{i} ≡ - k {θω}_{i}^{′} , \qquad ( 72 )$$

$$\begin{matrix}𝒰 ≡ {U}^{T} Φ {U}^{*} , Φ ≡ diag ( {e}^{i {ϕ}_{1}} - 1 , … , {e}^{i {ϕ}_{M}} - 1 ) , \\ \tilde{C} ≡ C - 𝒰 / 2 , Q = 2 ( \begin{matrix}A & \tilde{C} \\ {\tilde{C}}^{T} & B\end{matrix} ) , & ( 73 )\end{matrix}$$

$$c ≡ ( \begin{matrix}a \\ b\end{matrix} ) , a = {U}^{T} {Φβ}_{0} , b = {U}^{†} {Φα}_{0} , {c}_{0} = {α}_{0} {Φβ}_{0} , \qquad ( 74 )$$

and [symbol] represents the average over the positive P-representation.

It is noted that the displacement occurs after the linear-optical unitary, which matches the displacement δ/\sqrt{2} in the Doktorov transformation, i.e., α₀=β₀=δ/\sqrt{2}. It is further noted that Q's real part is positive-definite.

To see this, Q may be decomposed as:

$$\begin{matrix}Q = 2 {2}_{} ⊗ {Γ}^{- 1} + ( \begin{matrix}{M}_{} & - {M}_{} \\ - {M}_{} & {M}_{}\end{matrix} ) - ( \begin{matrix}0 & 𝒰 \\ {𝒰}^{T} & 0\end{matrix} ) & ( 75 ) \\ = 2 {2}_{} ⊗ {Γ}^{- 1} + ( \begin{matrix}{M}_{} & - {U}^{T} {diag ( {e}^{i {ϕ}_{j}} )}_{j = 1}^{M} {U}^{*} \\ - {U}^{†} {diag ( {e}^{i {ϕ}_{j}} )}_{j = 1}^{M} U & {M}_{}\end{matrix} ) , & ( 76 )\end{matrix}$$

where Γ≡diag(γ₁, . . . , γ_{M}).

The real part of Q may then be written as:

$$Re ( Q ) = 2 {2}_{} ⊗ {Γ}^{- 1} + ( \begin{matrix}{M}_{} & L \\ {L}^{T} & {M}_{}\end{matrix} ) , \qquad ( 77 )$$

where L≡Re(−U^{T} diag(e^{iϕj})ⱼ₌₁^{M}U*). Since ∥L∥ₒₚ≤1, Re(Q) is positive-definite, the integral always converges.

Using the Gaussian integral formula,

$$\int dq exp [ - q \cdot Q \cdot q / 2 + c \cdot q ] = \sqrt{\frac{{( 2 π )}^{2 M}}{\vert Q \vert}} exp ( \frac{1}{2} c \cdot {Q}^{- 1} \cdot c ) , \qquad ( 78 )$$

the analytical form of the Fourier components may be obtained as:

$$\begin{matrix}\tilde{G} ( k ) = 𝒩 \sqrt{\frac{{( 2 π )}^{2 M}}{\vert Q \vert}} exp ( \frac{1}{2} c \cdot {Q}^{- 1} \cdot c + {c}_{0} ) , \\ where & ( 79 ) \\ Q = ( \begin{matrix}2 {Γ}^{- 1} + {M}_{} & - {U}^{T} {diag ( {e}^{i {ϕ}_{j}} )}_{j = 1}^{M} {U}^{*} \\ - {U}^{†} {diag ( {e}^{i {ϕ}_{j}} )}_{j = 1}^{M} U & 2 {Γ}^{- 1} + {M}_{}\end{matrix} ) . & ( 80 )\end{matrix}$$

### More Detail of the Positive P-Representation

The generalized (positive) P-representation introduced above is described in further detail. Such generalized positive P representation may be written as:

$$\hat{ρ} = {\int }_{{ℂ}^{2 M}} P ( α , β ) \hat{Λ} ( α , β ) d α d β , \hat{Λ} ( α , β ) ≡ \frac{\vert α 〉 〈 {β}^{*} \vert}{〈 {β}^{*} \vert α 〉} , \qquad ( 81 )$$

where |α [symbol] and |β* [symbol] are coherent states.

The generalized P-representation represents one of the quasi-probability distributions of a bosonic state. An important property of the generalized P-representation is that the distribution P(α,β) can always be chosen non-negative (hence and name positive P-representation) and the expectation value of a normal-ordered operator can be readily computed.

For simplicity, a simpler version may be used, where it is assumed that the Glauber-Sudarshan P-function exists, which is written as

\hat{ρ}= [symbol] d²αP_{GS}(α)|α [symbol] [symbol] α|, (82)

for a single-mode state.

It is noted that although the existence of the Glauber-Sudarshan P-function is assumed for simplicity, such assumption may be true for arbitrary density matrices. The assumption is that the positive P-representation can be written as

$$P ( α , β ) = \frac{1}{4 {π}^{2}} exp ( - \frac{{\vert α - {β}^{*} \vert}^{2}}{4} ) 〈 ( α + {β}^{*} ) / 2 \vert \hat{ρ} \vert ( α + {β}^{*} ) / 2 〉 . \qquad ( 83 )$$

If the assumption is true, then it guarantees that the representation is positive and real.

By directly substituting the representation, it is obtained that:

$$P ( α , β ) = \frac{1}{4 {π}^{2}} \int {P}_{GS} ( γ ) exp ( - \frac{1}{2} {\vert α - γ \vert}^{2} - \frac{1}{2} {\vert {β}^{*} - γ \vert}^{2} ) {d}^{2} γ . \qquad ( 84 )$$

In the meanwhile, for an analytical function ƒ:

$$f ( γ ) = \frac{1}{2 π} {\int }_{ℂ} f ( α ) exp ( - \frac{1}{2} {\vert α - γ \vert}^{2} ) {d}^{2} α . \qquad ( 85 )$$

It can be shown that, for example at γ=0,

$${\int }_{ℂ} f ( α ) exp ( - \frac{1}{2} {\vert α \vert}^{2} ) {d}^{2} α = 2 π exp ( \frac{1}{2} \frac{{\partial }^{2}}{\partial α \partial {β}^{*}} ) f ( α ) {\vert}_{α = 0} = 2 π f ( 0 ) , \qquad ( 86 )$$

where the last equality holds because the function is analytic.

Using this property, the following may be obtained from Eq. (84)

$${\int }_{{ℂ}^{2}} \hat{Λ} ( α , β ) P ( α , β ) {d}^{2} α {d}^{2} β \qquad ( 87 )$$

$$= \frac{1}{4 {π}^{2}} {\int }_{{ℂ}^{3}} {d}^{2} α {d}^{2} β {d}^{2} γ \hat{Λ} ( α , β ) {P}_{GS} ( γ ) exp ( - \frac{1}{2} {\vert α - γ \vert}^{2} - \frac{1}{2} {\vert {β}^{*} - γ \vert}^{2} ) \qquad ( 88 )$$

$$= {\int }_{ℂ} {d}^{2} α {P}_{GS} ( α ) \vert α 〉 〈 α \vert = \hat{ρ} , \qquad ( 89 )$$

which proves the assumption above.

It may be further shown that the expectation value of a normal-ordered operator can be computed by averaging over the phase-space variable. For example, when computing for a single-mode: \hat{α}\hat{α}^{†}\hat{α}\hat{α}^{†}:=α^{†2}\hat{α}²,

$$Tr [ \hat{ρ} : \hat{a} {\hat{a}}^{†} \hat{a} {\hat{a}}^{†} : ] = Tr [ \hat{ρ} {\hat{a}}^{†2} {\hat{a}}^{2} ] = {\int }_{{ℂ}^{2}} P ( α , β ) Tr [ \hat{Λ} ( α , β ) {\hat{a}}^{†2} {\hat{a}}^{2} ] d α d β \qquad ( 90 )$$

$$= {\int }_{{ℂ}^{2}} P ( α , β ) \frac{〈 {β}^{*} \vert {\hat{a}}^{†2} {\hat{a}}^{2} \vert α 〉}{〈 {β}^{*} \vert α 〉} d α d β = {\int }_{{ℂ}^{2}} P ( α , β ) {β}^{2} {α}^{2} d β d β . \qquad ( 91 )$$

Therefore, the expectation value may be directly integrated or estimated by sampling (α,β) from P and averaging α²β² over the samples. The same procedure works for any normal-ordered operator ƒ(\hat{α}, \hat{α}^{†}) by replacing \hat{α}→α and \hat{α}^{†}→β. Especially when the operator is written as a function of \hat{n}, g(\hat{n}), then the corresponding phase-variable is given by g(αβ).

When applying a linear-optical circuit to a given input state, the quantum state transforms as

\hat{ρ}= [symbol] P(α,β)\hat{Λ}(α,β)dαdβ→\hat{ρ}= [symbol] P(α,β)\hat{Λ}(Uα,U*β)dαdβ. (92)

which is written for the positive P-representation as

\hat{ρ}= [symbol] P(α,β)\hat{Λ}(α,β)dαdβ→\hat{ρ}= [symbol] P(α,β)\hat{Λ}(Uα,U*β)dαdβ. (93)

Therefore, sampling from the positive P-representation of the output state of the linear-optical circuit is equivalent to sampling from the positive P-representation of the input state and transform the phase variable as (α,β)→(α′,β′)=(Uα,U*β).

### Numerical Simulation

The various algorithms above may be numerically simulated to generate molecular vibronic spectra.

The first example involves photo-electron spectra of formic acid (CH₂O₂, 1¹A′→1²A′). To quantify the performance of the scheme based on Gaussian boson sampling and the proposed quantum-inspired classical algorithm, the ideal FCP distribution, generated by directly computing probability distributions of the outcomes of Gaussian boson sampling, may be compared to the empirical distributions obtained by Gaussian boson sampling simulation and the proposed classical algorithm.

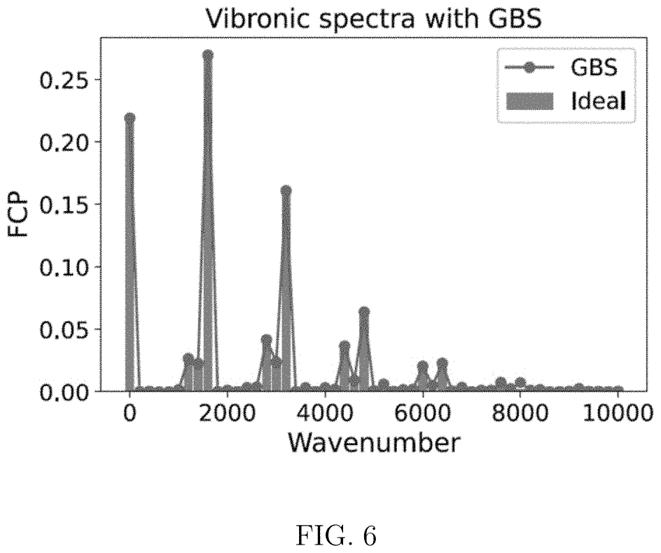

It may be emphasized that the ideal Gaussian boson sampling assumes no errors and losses. FIGS. 3 and 6 show that both schemes predict the ground truth distribution well. In particular, FIG. 3 shows an example data and logic flow for the quantum-inspired classical algorithm of FIG. 1 for generating molecular vibronic spectra, whereas FIG. 6 shows comparison of molecular vibronic spectra for CH₂O₂, 1¹A′→1²A′ as generated based on direct computation (ideal bars) and based on Gaussian boson sampling simulation (“GBS” points and curve).

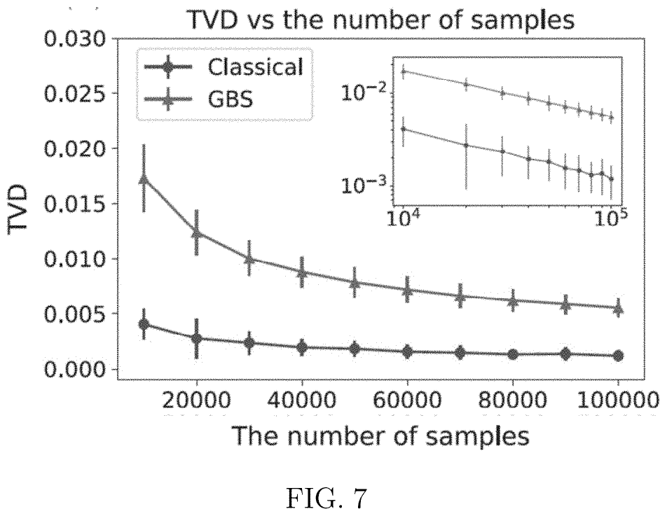

In FIG. 7, the total variation distances by varying the number of samples is shown. The total variance distance (TVD) is defined as

$$TVD ≡ \frac{1}{2} {\sum }_{{ω}_{vib}} \vert FCP ( {ω}_{vib} ) - eFCP ( {ω}_{vib} ) \vert . \qquad ( 94 )$$

FIG. 7 particular shows comparison of total variance distance (TVD) between ideal direct computation (upper curve with circular points) and the quantum-inspired classical algorithm (lower curve with triangular points) of FIG. 3. FIG. 7 shows that while both schemes accuracy increases as the number of samples increases, the proposed classical algorithm provides a better precision (about 5 times).

The second example is generated from a recent Gaussian boson sampling experiments samples in order to verify that the quantum-inspired classical algorithm operates in the quantum supremacy regime.

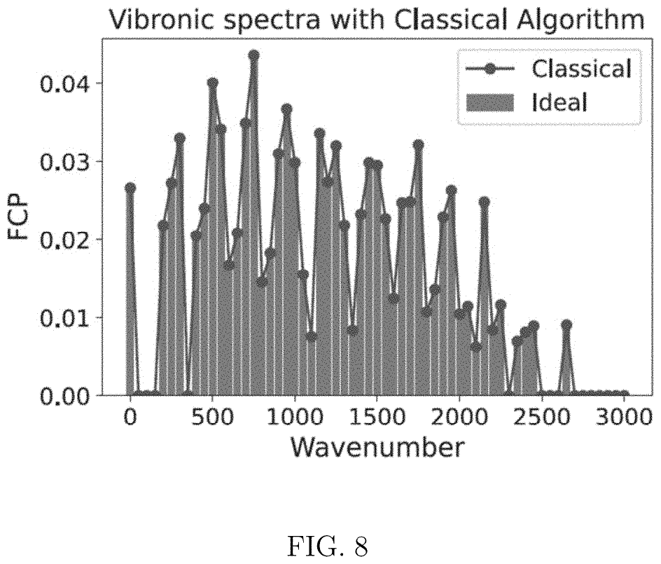

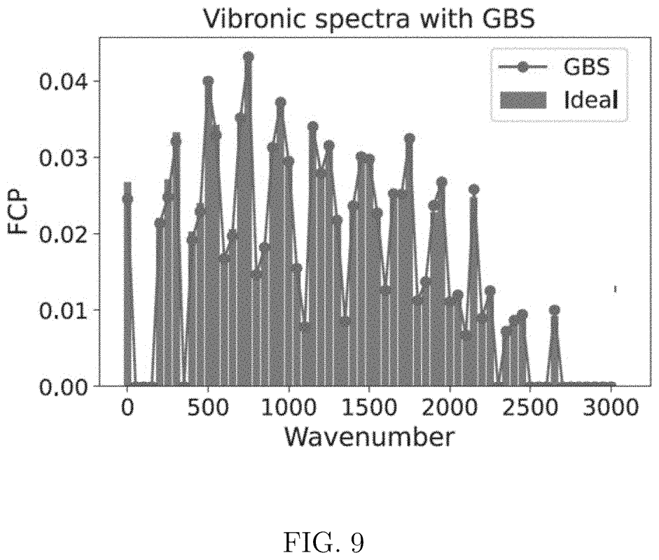

Specifically, arbitrarily chosen virtual harmonic angular frequencies w′ are introduced for the output modes to demonstrate that the algorithm can even simulate a quantum supremacy regime for molecular vibronic spectra generation. For FIGS. 8 and 9, nonzero weights are set only for the first 6 modes to compare with its ideal distribution. More details for this method are further disclosed below.

Since it corresponds to a Gaussian boson sampling on the small number of marginal modes, all ideal FC factors may be directly computed. FIGS. 8 and 9 again show that both schemes predict the virtual spectra correctly, while the spectra from the classical algorithm is more accurate (about 4 times) in terms of total variation distance.

Also, it is further observed that the total variance distance from the ideal Gaussian boson sampling is smaller than the one from the experimental Gaussian boson sampling, which is due to the experimental noise.

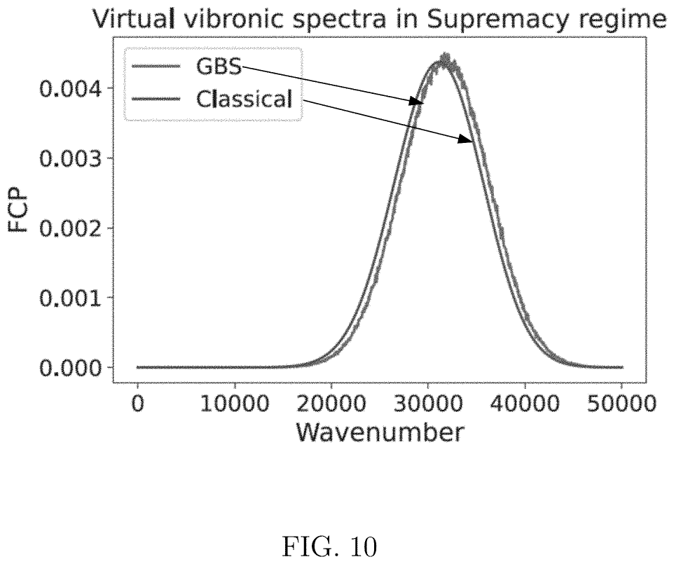

Finally, a random weight vector w′ has been generated for all 144 modes and compared the spectra from Gaussian boson sampling and classical algorithm, which is shown in FIG. 10. While the spectra generated from Gaussian boson sampling fluctuates, which may be due to experimental noise, the classical algorithms spectra has the very similar shape to Gaussian boson samplings spectra. Therefore, it confirms that the quantum-inspired classical algorithm gives a consistent result as the Gaussian boson sampler in the quantum supremacy regime.

### Approximation Algorithm of Hafnian

An example algorithm to approximate the hafnian above is provided. First, it is known that

$${x}_{1}^{{n}_{1}} {x}_{2}^{{n}_{2}} ⋯ {x}_{M}^{{n}_{M}} = \frac{1}{n !} {\sum }_{{v}_{1} = 0}^{{n}_{1}} ⋯ {\sum }_{{v}_{M} = 0}^{{n}_{M}} {( - 1 )}^{{\sum }_{i = 1}^{M} {v}_{i}} ( \begin{matrix}{n}_{1} \\ {v}_{1}\end{matrix} ) ⋯ ( \begin{matrix}{n}_{M} \\ {v}_{M}\end{matrix} ) {( {\sum }_{i = 1}^{M} {h}_{i} {x}_{i} )}^{n} , \qquad ( 95 )$$

where hᵢ=nᵢ/2−vᵢ.

Also a known proposition states that for z=(z₁, . . . , z_{M})^{T}˜ [symbol] (0,Σ), where Σ is a real symmetric matrix and z can be a complex variable vector,

$$haf ( {Σ}_{n} ) = {𝔼}_{z} [ {\prod }_{i = 1}^{M} {z}_{i}^{{n}_{i}} ] = \frac{1}{( n / 2 ) !} {\sum }_{{v}_{1} = 0}^{{n}_{1}} ⋯ {\sum }_{{v}_{M} = 0}^{{n}_{M}} {( - 1 )}^{{\sum }_{i = 1}^{M} {v}_{i}} ( \begin{matrix}{n}_{1} \\ {v}_{1}\end{matrix} ) ⋯ ( \begin{matrix}{n}_{M} \\ {v}_{M}\end{matrix} ) {( \frac{{h}^{T} Σ h}{2} )}^{n / 2} , \qquad ( 96 )$$

where n=n₁+ . . . +n_{M} and h=(n₁/2−v₁, . . . , n_{M}/2−v_{M})^{T} and n is even.

It is noted that the equality between the hafnian and the sum in Eq. (96) holds even for general complex symmetric matrices. Especially when nᵢ=1 for all i∈{1, . . . , n},

$${𝔼}_{z} [ {\prod }_{i = 1}^{n} {z}_{i} ] = \frac{1}{( n / 2 ) !} {\sum }_{{v}_{1} = 0}^{1} … {\sum }_{{v}_{M} = 0}^{1} {( - 1 )}^{{\sum }_{i = 1}^{n} {v}_{i}} {( \frac{{h}^{T} \sum h}{2} )}^{n / 2} \qquad ( 97 )$$

$$= \frac{1}{{2}^{n}} {\sum }_{{v}_{1} = 0}^{1} … {\sum }_{{v}_{n} = 0}^{1} {( - 1 )}^{{\sum }_{i = 1}^{n} {v}_{i}} \frac{{2}^{n}}{( n / 2 ) !} {( \frac{{h}^{T} \sum h}{2} )}^{n / 2} \qquad ( 98 )$$

$$= {𝔼}_{v} [ {( - 1 )}^{{\sum }_{i = 1}^{n} {v}_{i}} \frac{{2}^{n / 2}}{( n / 2 ) !} {( {h}^{T} \sum h )}^{n / 2} ] , \qquad ( 99 )$$

where h=(½−v₁, . . . , ½−v_{M})^{T}. In this case, M=n.

Therefore,

$${( - 1 )}^{{\sum }_{i = 1}^{n} {v}_{i}} \frac{{2}^{n / 2}}{( n / 2 ) !} {( {h}^{T} \sum h )}^{n / 2} \qquad ( 100 )$$

is an unbiased estimator for the hafnian in the sense that

$${𝔼}_{v} [ {( - 1 )}^{{\sum }_{i = 1}^{n} {v}_{i}} \frac{{2}^{n / 2}}{( n / 2 ) !} {( {h}^{T} \sum h )}^{n / 2} ] = haf ( \sum ) . \qquad ( 101 )$$

Note that

$$\vert \frac{{2}^{n / 2}}{( n / 2 ) !} {( {h}^{T} \sum h )}^{n / 2} \vert = \vert \frac{{2}^{n / 2}}{( n / 2 ) !} {( \frac{n}{4} {\hat{h}}^{T} \sum \hat{h} )}^{n / 2} \vert = \vert \frac{{n}^{n / 2}}{( n / 2 ) ! {2}^{n / 2}} {( {\hat{h}}^{T} \sum \hat{h} )}^{n / 2} \vert \leq \frac{{( n ‖ \sum ‖ )}^{n / 2}}{( n / 2 ) ! {2}^{n / 2}} . \qquad ( 102 )$$

Therefore, in general, the estimate by sampling v and using the estimator has an error bound given by Chernoff bound as

$$Pr [ \vert \tilde{p} - haf ( \sum ) \vert > ϵ \frac{{( n ‖ \sum ‖ )}^{n / 2}}{( n / 2 ) ! {2}^{n / 2}} ] \leq 2 exp ( - \frac{1}{2} {ϵ}^{2} T ) . \qquad ( 103 )$$

Here, ∥Σ∥ is the spectral norm, i.e., the maximum singular value.

The Fourier components of molecular vibronic spectra, which is given by

$$\tilde{G} ( k ) = \frac{haf ( {\sum }_{n} )}{Z n !} . \qquad ( 104 )$$

Note that the operator norm of the matrix Σ_{α,β*} is 1 (see Eq. (??)). Since a matrix's submatrix's operator norm is smaller than or equal to the matrix's norm, when the vector n is composed 0 or 1, Σₙ's operator norm is smaller than or equal to 1.

In addition, when n has a component larger than 1, hafnian for a matrix obtained may be computed by repeating the row and column. Nevertheless, when repeating the row and column the operator norm does not increase as much as n!, i.e.,

$$\frac{‖ {\sum }_{n} ‖}{n !} \leq ‖ \sum ‖ . \qquad ( 105 )$$

Therefore, the estimate by sampling x and using the estimator has an error bound given by Chernoff bound as

$$Pr [ \vert \tilde{q} - \frac{haf ( \sum )}{Z n !} \vert ≳ ϵ \frac{{e}^{n / 2}}{\sqrt{π n} Z} ] \leq 2 exp ( - \frac{1}{2} {ϵ}^{2} T ) , \qquad ( 106 )$$

where Z=\sqrt{Πᵢ₌₁ⁿ cosh rᵢ} and we have used Stirling's formula, N!≈\sqrt{2πN}(N/e)^{N} (more precisely, \sqrt{2πN}(N/e)^{N}e^{1/12N+1}<N!<\sqrt{2πN}(N/e)^{N}e^{1/12N}). Thus, if Z>e^{n/2}, the estimation error is smaller than e with exponentially small failure probability if we choose the number of samples as T=O(1/ϵ²).

For nonzero mean, one may again employ a similar formula for z˜N(μ, Σ):

$$lhaf ( {\sum }_{n} ) = {𝔼}_{z} [ {\prod }_{i = 1}^{M} {z}_{i}^{{n}_{i}} ] \qquad ( 107 )$$

$$= {\sum }_{{v}_{1} = 0}^{{n}_{1}} … {\sum }_{{v}_{M} = 0}^{{n}_{M}} {( - 1 )}^{{\sum }_{i = 1}^{M} {v}_{i}} ( \begin{matrix}{n}_{1} \\ {v}_{1}\end{matrix} ) … ( \begin{matrix}{n}_{M} \\ {v}_{M}\end{matrix} ) {\sum }_{r = 0}^{[ n / 2 ]} \frac{{( \frac{{h}^{T} \sum h}{2} )}^{r} {( h \cdot μ )}^{n - 2 r}}{r ! ( n - 2 r ) !} , \qquad ( 108 )$$

where n=n₁+ . . . +n_{M} and h=(n₁/2−v₁, . . . , n_{M}/2−v_{M})^{T} and Σₙ is obtained by replacing the diagonal elements of Σ by μ and repeating ith row and column for nᵢ times. Again, let nᵢ=1 for all i's. In this case, M=n, and

$$lhaf ( \sum ) = {𝔼}_{z} [ {\prod }_{i = 1}^{n} {z}_{i} ] = {\sum }_{{v}_{1} = 0}^{1} … {\sum }_{{v}_{n} = 0}^{1} {( - 1 )}^{{\sum }_{i = 1}^{n} {v}_{i}} {\sum }_{r = 0}^{[ n / 2 ]} \frac{{( \frac{{h}^{T} \sum h}{2} )}^{r} {( h \cdot μ )}^{n - 2 r}}{r ! ( n - 2 r ) !} \qquad ( 109 )$$

$$= \frac{1}{{2}^{n} [ n / 2 ]} {𝔼}_{v , r} [ {( - 1 )}^{{\sum }_{i = 1}^{n} {v}_{i}} \frac{{2}^{n} [ n / 2 ] {( \frac{{h}^{T} \sum h}{2} )}^{r} {( h \cdot μ )}^{n - 2 r}}{r ! ( n - 2 r ) !} ] . \\ Here , \qquad ( 110 )$$

$$\vert \frac{{2}^{n} [ n / 2 ] {( \frac{{h}^{T} \sum h}{2} )}^{r} {( h \cdot μ )}^{n - 2 r}}{r ! ( n - 2 r ) !} \vert = \frac{[ n / 2 ] {{n}^{n / 2} ( {\hat{h}}^{T} \sum \hat{h} )}^{r} {( \hat{h} \cdot μ )}^{n - 2 r}}{{2}^{r} r ! ( n - 2 r ) !} \leq \frac{[ n / 2 ] {n}^{n / 2} {‖ Σ ‖}^{r} {‖ μ ‖}^{n - 2 r}}{{2}^{r} r ! ( n - 2 r ) !} \qquad ( 111 )$$

Therefore, the Chernoff bound provides

$$Pr [ \vert p - l h af ( \sum ) \vert > ϵ \frac{[ n / 2 ] {n}^{n / 2} {‖ Σ ‖}^{r} {‖ μ ‖}^{n - 2 r}}{{2}^{r} r ! ( n - 2 r ) !} ] \leq 2 exp ( - \frac{1}{2} {ϵ}^{2} T ) . \qquad ( 112 )$$

Especially when ∥Σ∥≤1, which is the case that we are interested in,

$$Pr [ \vert p - l h af ( \sum ) \vert > ϵ \frac{[ n / 2 ] {n}^{n / 2} {‖ μ ‖}^{n - 2 r}}{{2}^{r} r ! ( n - 2 r ) !} ] \leq 2 exp ( - \frac{1}{2} {ϵ}^{2} T ) . \qquad ( 113 )$$

The error bound clearly depends on the mean vector μ, which makes the bound more nontrivial than the hafnian case.

### Other Techniques: Chernoff Bound

The accuracy of molecular vibronic spectra generation using Gaussian boson sampling may be derived. For example, let S={mᵢ}ᵢ₌₁^{M} be the sample set, and for a fixed ω_{vib}, the random variable may be the indicator I(m, ω_{vib}) i.e., S→I(S, ω_{vib})={I(mᵢ,ω_{vib})}ᵢ₌₁^{N}, where

$$I ( m , {ω}_{v i b} ) = 1 if {w}^{′} \cdot m ∈ [ {ω}_{v i b} - \frac{{Δω}_{v i b}}{2} , {ω}_{v i b} + \frac{{Δω}_{v i b}}{2} ] \qquad ( 114 )$$

$$I ( m , {ω}_{v i b} ) = 0 otherwise . \qquad ( 115 )$$

Thus, the Chernoff inequality for a given ω_{vib} may become

$$Pr [ \vert FCP ( {ω}_{v i b} ) - \frac{1}{N} {\sum }_{m ∈ 𝒮} I ( m , {ω}_{v i b} ) \vert \geq ϵ ] \leq 2 {e}^{- 2 N {ϵ}^{2}} , \qquad ( 116 )$$

where Σ_{m∈S}I(m, ω_{vib})/N is the estimate eFCP(ω_{vib}).

Then the Chernoff inequality may be expressed as:

Pr[| [symbol] (X̅)−X̅|≥ϵ]≤2e^{-2Nϵ}^{²}, (117)

where X̅=(X₁+ . . . +X_{N})/N is the sample average and Xᵢ∈[0, 1].

### Methods for Numerical Results Above

The parameters for FIGS. 3 and 6-7 are provided in J. Huh, G. G. Guerreschi, B. Peropadre, J. R. McClean, and A. Aspuru-Guzik, Boson sampling for molecular vibronic spectra, Nature Photonics 9, 615 (2015), which is herein incorporated by reference.

For FIGS. 8 and 9 above, the first 6 elements are selected as ω′ as [1000, 500, 300, 200, 400, 250] and zeros are used for the remaining elements. In addition, the raw data of the recent Gaussian boson sampling is provided in https://quantum.ustc.edu.cn/web/node/951.

For the simulation, the frequencies in the unit of Δω_{vib} are approximated depending on the number of bins and domain. As explained above, increasing the resolution requires an additional cost for the fast Fourier transform, which is only poly(K).

The generalized P-representation of a squeezed state is given by

$$P ( α , β ) = \frac{\sqrt{1 + γ}}{π γ} {e}^{- ( {α}^{2} + {β}^{2} ) ( {γ}^{- 1} + 1 / 2 ) + α β} , \qquad ( 118 )$$

where α and β are real numbers, and γ=e^{2r} with r>0 being the squeezing parameter.

The various classical algorithm above may be performed by any type of computing system include a set of processors, memories, and other components including but not limited to various user interfaces and network units. At least one memory may computer instructions, when executed by the set of processors, causes the computing system to perform the various algorithms described above.

Finally, it is to be understood that the following claims are intended to cover all of the generic and specific features of the invention herein described and all statements of the scope of the invention which, as a matter of language, might be said to fall therebetween.

What is claimed:

1. A method for estimating a transition spectra in a bosonic system having M bosonic modes, M being an integer equal to or larger than 2, the method comprising:
determining a unitary operation modified from a transition operator associated with the bosonic system;
processing each of N sampling bosonic states of the bosonic system in a representation space of the bosonic system to generate N sets of samples using at least the unitary operation, wherein each set of samples correspond to one of the N sampling bosonic states and are sampled from at least one variable in the representation space, N being a positive integer;
generating Fourier components of the transition spectra based on the N sets of samples; and
inverse-transforming the Fourier components to estimate the transition spectra.

2. The method of claim 1, wherein the unitary operation comprises a complex mixed position and momentum operator.

3. The method of claim 1, wherein each of the N sampling bosonic states comprises a non-Gaussian state of the tM bosonic modes.

4. The method of claim 1, wherein each of the N sampling bosonic states comprises a Gaussian state of the M bosonic modes.

5. The method of claim 1, wherein each of the N sampling bosonic states of the M bosonic modes is expressed in a positive P-representation in the representation space of the bosonic system for the processing of generating the corresponding set of samples in the representation space.

6. The method of claim 5, wherein the M bosonic modes comprise M molecular vibronic modes.

7. The method of claim 5, wherein the positive P-representation of the each of the N sampling bosonic states of the M bosonic modes and for the processing therein represents a quasi-probability distribution of the each of the N sampling bosonic states of the M bosonic modes.

8. The method of claim 7, wherein the phase space for the positive P-representation comprises 2M dimensions.

9. The method of claim 7, wherein processing the each of the N sampling bosonic states of the M bosonic modes in the positive P-representation to generate the corresponding set of samples in the representation space comprises:
selecting M pairs of complex numbers for two representation space variables of the each of the N sampling bosonic states in the representation space;
transforming the M pairs of complex numbers by applying a unitary matrix corresponding to the unitary operation to generate a transformed M pairs of complex numbers; and
generating the corresponding set of samples from the transformed M pairs of complex numbers.

10. The method of claim 9, wherein the transition operator associated with the bosonic system is decomposed into the unitary operation, a dressing operation, and a displacement operation.

11. The method of claim 9, wherein at least one of the two phase space variables is associated with mean quantum numbers of M-mode coherent states of the bosonic system.

12. The method of claim 1, wherein:
the transition operator associated with the bosonic system is decomposed into the unitary operation, a dressing operation, a displacement operation, and a two-mode squeezing operation;
M comprises a even integer;
the bosonic system comprises a molecular vibronic system; and
the M bosonic modes comprises M/2 vibronic modes of the molecular vibronic system and M/2 auxiliary modes.

13. A computing system for estimating a transition spectra in a bosonic system having M bosonic modes, M being an integer equal to or larger than 2, the system comprising one or more processors and a memory for storing computer instructions, the one or more processors, when executing the computer instructions, are configured to cause the computing system to:
determine a unitary operation modified from a transition operator associated with the bosonic system;
process each of N sampling bosonic states of the bosonic system in a representation space of the bosonic system to generate N sets of samples using at least the unitary operation, wherein each set of samples correspond to one of the N sampling bosonic states and are sampled from at least one variable in the representation space, N being a positive integer;
analytically generate Fourier components the transition spectra based on the N sets of samples; and
inverse-transform the Fourier components to estimate the transition spectra.

14. The computing system of claim 13, wherein the unitary operation comprises a complex mixed position and momentum operator.

15. The computing system of claim 13, wherein each of the N sampling bosonic states comprises a non-Gaussian state of the tM bosonic modes.

16. The computing system of claim 13, wherein each of the N sampling bosonic states comprises a Gaussian state of the M bosonic modes.

17. The computing system of claim 16, wherein each of the N sampling bosonic states of the M bosonic modes is expressed in a positive P-representation in the representation space of the bosonic system for the processing of generate the corresponding set of samples in the representation space.

18. The computing system of claim 17, wherein:
the M bosonic modes comprise M molecular vibronic modes, and wherein the positive P-representation of the each of the N sampling bosonic states of the M bosonic modes and for the processing therein represents a quasi-probability distribution of the each of the N sampling bosonic states of the M bosonic modes; and
the phase space for the positive P-representation comprises 2M dimensions.

19. The computing system of claim 18, wherein to process the each of the N sampling bosonic states of the M bosonic modes in the positive P-representation to generate the corresponding set of samples in the representation space comprises:
select M pairs of complex numbers for two representation space variables of the Gaussian state in the representation space;
transform the M pairs of complex numbers by applying s unitary matrix corresponding to the unitary operation to generate a transformed M pairs of complex numbers; and
generate the corresponding set of samples from the transformed M pairs of complex numbers.

20. The computing system of claim 19, wherein:
the transition operator associated with the bosonic system is decomposed into the unitary operation, a dressing operation, and a displacement operation; and
at least one of the two phase space variables is associated with mean quantum numbers of M-mode coherent states of the bosonic system.
